(19) United States
(12) Patent Application Publication
(10) Pub. No.: US 2024/0189874 A1
(43) Pub. Date: Jun. 13, 2024

(54) COMMUNITY COMPOST MANAGEMENT SYSTEM

(71) Applicant: Big Belly Solar LLC, Needham, MA (US)

(72) Inventors: Jeffrey Thomas Satwicz, Winchester, MA (US); Ethan Matthew Schwartz, Sharon, MA (US)

(21) Appl. No.: 18/533,512

(22) Filed: Dec. 8, 2023

Related U.S. Application Data
(60) Provisional application No. 63/386,877, filed on Dec. 9, 2022.

(51) Int. Cl. B09B 3/32; G07C 9/00; H04W 4/021

(52) U.S. Cl. CPC B09B 3/32; G07C 9/00309; H04W 4/021

(57) ABSTRACT

A system includes a solar-powered secure receptacle comprising a control system, a scanning module in communication with the control system, a wireless communication device, and a lockable hopper in communication with the control system; a network device in communication with the solar-powered secure receptacle via the wireless communication device, the network device configured to manage access allowance for users of the solar-powered secure receptacle via mobile devices; and a user application downloadable onto the mobile devices, wherein the user application is configured: to present to users on the mobile devices a location and availability of the solar-powered secure receptacle; to unlock the lockable hopper in the solar-powered secure receptacle using the scanning module; to present information what items can be placed in the solar-powered secure receptacle; and to report issues with the solar-powered secure receptacle. The receptacle can be used for composting or receiving and processing compost material.

### PRIORITY CLAIM

The present application is a non-provisional application of U.S. Provisional App. No. 63/386,877, filed on Dec. 9, 2022.

### BACKGROUND

### 1. Technical Field

The present disclosure relates to sensor networks and more specifically to a community compost management system including a secure drop box for receiving compost, a software application downloadable on mobile devices for users and a network server operating software for managing the access of and use of the secure drop box for receiving compost.

### 2. Introduction

Composting of waste food items is of a growing interest to many people. However, in some areas such as urban areas where people live in apartment buildings or condominium units, it becomes more difficult to compost food. There is a lack of proper space for performing basic composting. Composting facilities might be too far away for a typical urban user. The result is a lack of composting. Particularly in high population areas, the lack of composting can cause an excess of smell, rodents or other wildlife, irritated neighbors and so forth.

### SUMMARY

Additional features and advantages of the disclosure will be set forth in the description which follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The approaches set forth herein address the issue of composting in some urban areas or other areas by introducing a compost management system with three components. The first is a composting unit such as a solar-powered secure compost drop box that can be positioned in a neighborhood. The second is a software application that can be downloadable on a mobile device or that is accessible on a website via a browser. Users can sign up or register to enable them to have the rights or authority to access the solar-powered secure compost drop box to deposit waste food. The third component is a network server operating software that manages the access and use of the solar-powered secure compost drop box or a plurality of solar-powered secure compost drop boxes and can also monitor and manage a pick-up operation.

The user mobile device can access or open the solar-powered secure compost drop box via an RFID (radio frequency identification), Bluetooth sensor, near-field communication protocol (NFC), or other electronic communication method or protocol.

An example system can include a solar-powered secure receptacle including a control system, a scanning module in communication with the control system, a wireless communication device, and a lockable hopper in communication with the control system; a network device in communication with the solar-powered secure receptacle via the wireless communication device, the network device configured to manage access allowance for users of the solar-powered secure receptacle via mobile devices; and a user application downloadable onto the mobile devices. The user application is configured: to present to users on the mobile devices a location and availability of the solar-powered secure receptacle; to unlock the lockable hopper in the solar-powered secure receptacle using the scanning module; to present information what items can be placed in the solar-powered secure receptacle and to report issues with the solar-powered secure receptacle.

The solar-powered secure receptacle can include a solar-powered secure compost receptacle.

An example method can include a method of managing a compost receptacle, the method including one or more of receiving, at a receptacle having a scanning module, via an interaction with a mobile device, an identification of a user; confirming that the user is enrolled in a program associated with accessing the receptacle; when the user is enrolled in the program, unlocking a hopper of the receptacle; receiving compost material into the receptacle; reporting a fullness level of the receptacle and which users access the receptacle to a network device; performing a collection operation for the receptacle and other receptacles according to a schedule that is based on the fullness level of the receptacle and a fullness level of the other receptacles; and managing through a program on the network device who is granted access to the receptacle and the other receptacles.

In some aspects, the techniques described herein relate to a method of operating a network server, the method including: confirming that a user which has interacted via a mobile device with a receptacle having a scanning module, is enrolled in a program associated with accessing the receptacle; when the user is enrolled in the program, transmitting a signal to unlock a hopper of the receptacle, wherein the receptacle receives compost material; receiving a report of a fullness level of the receptacle and which users access the receptacle; initiating a collection operation for the receptacle and other receptacles according to a schedule that is based on the fullness level of the receptacle and a respective fullness level of the other receptacles; and managing through a program who is granted access to the receptacle and the other receptacles.

In some aspects, the techniques described herein relate to a system including: at least one processor; and a computer-readable storage device storing instructions which, when executed by the at least one processor, cause the at least one processor to be configured to: confirm that a user which has interacted via a mobile device with a receptacle having a scanning module, is enrolled in a program associated with accessing the receptacle; when the user is enrolled in the program, transmit a signal to unlock a hopper of the receptacle, wherein the receptacle receives compost material; receive a report of a fullness level of the receptacle and which users access the receptacle; initiate a collection operation for the receptacle and other receptacles according to a schedule that is based on the fullness level of the receptacle and a respective fullness level of the other receptacles; and manage through a program who is granted access to the receptacle and the other receptacles.

In some aspects, the techniques described herein relate to a solar-powered secure receptacle including: a control system; a scanning module in communication with the control system; a wireless communication device; and a lockable hopper in communication with the control system, wherein: the wireless communication device communicates with a network device; the network device configured to manage access allowance for a user of the solar-powered secure receptacle via a mobile device; and a user application downloadable onto the mobile device is configured to: present to the user on the mobile device a location and availability of the solar-powered secure receptacle; unlock the lockable hopper in the solar-powered secure receptacle using the scanning module; present information what items can be placed in the solar-powered secure receptacle; and report issues with the solar-powered secure receptacle.

In some aspects, the techniques described herein relate to a method of operating a receptacle, the method including: receiving, at a receptacle having a scanning module, via an interaction with a mobile device, an identification of a user; obtaining a confirmation that the user is enrolled in a program associated with accessing the receptacle; when the user is enrolled in the program, unlocking a hopper of the receptacle; receiving compost material into the receptacle; and reporting a fullness level of the receptacle and which users access the receptacle to a network server, wherein a collection operation for the receptacle and other receptacles is performed according to a schedule that is based on the fullness level of the receptacle and a fullness level of the other receptacles and wherein the network server manages who is granted access to the receptacle and the other receptacles.

In some aspects, the techniques described herein relate to a storage receptacle including: a scanning module; a hopper; at least one processor; and a computer-readable storage device storing instructions which, when executed by the at least one processor, cause the at least one processor to be configured to: receive, via an interaction with a mobile device, an identification of a user; obtain a confirmation that the user is enrolled in a program associated with accessing the storage receptacle; when the user is enrolled in the program, unlock the hopper; receive compost material into the storage receptacle; and report a fullness level of the storage receptacle and which users access the storage receptacle to a network server, wherein a collection operation for the storage receptacle and other storage receptacles is performed according to a schedule that is based on the fullness level of the storage receptacle and a fullness level of the other storage receptacles and wherein the network server manages who is granted access to the storage receptacle and the other storage receptacles.

In some aspects, a method can include: receiving a plurality of fullness levels associated with a plurality of distributed solar-powered compost receptacles; obtaining a pickup schedule; and assigning, based on one or more of the plurality of fullness levels and the pickup schedule, a drop-off time to a user to drop of compost at an assigned compost receptacle.

In some aspects, a system can include: at least one processor; and a computer-readable storage device storing instructions which, when executed by the at least one processor, cause the at least one processor to be configured to: receive a plurality of fullness levels associated with a plurality of distributed solar-powered compost receptacles; obtain a pickup schedule; and assign, based on one or more of the plurality of fullness levels and the pickup schedule, a drop-off time to a user to drop of compost at an assigned compost receptacle.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

In order to describe the manner in which the above-recited and other advantages and features of the disclosure can be obtained, a more particular description of the principles briefly described above will be rendered by reference to specific aspects thereof which are illustrated in the appended drawings. Understanding that these drawings depict only exemplary aspects of the disclosure and are not therefore to be considered to be limiting of its scope, the principles herein are described and explained with additional specificity and detail through the use of the accompanying drawings in which:

FIG. 1 illustrates an example system, according to some aspects of this disclosure;

FIG. 2 illustrates an example architecture for remotely controlling electrically-powered compactors or other publicly available object, according to some aspects of this disclosure;

FIG. 3 illustrates an example storage receptacle, according to some aspects of this disclosure;

FIGS. 4A-D illustrate an exemplary network including the various components, according to some aspects of this disclosure;

FIG. 5 illustrates an exemplary method aspect, according to some aspects of this disclosure;

FIG. 6 illustrates an exemplary method aspect, according to some aspects of this disclosure;

FIG. 7 illustrates another exemplary method aspect, according to some aspects of this disclosure; and

FIG. 8 illustrates another exemplary method aspect related to scheduling users, according to some aspects of this disclosure.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Described herein are a number of different concepts primarily related to how to manage access to a storage receptacle which can include, for example, a receptacle for receiving compost or waste food. To address the problem outlined above with respect to composting activities within an urban area, this disclosure provides a solution which combines the provisioning of convenient secure compost drop boxes or receptacles placed in a neighborhood and includes a software application downloadable on a user mobile device and that works in coordination with a program on a network computer for managing access and use of the receptacles. While composting is provided as an example use of the receptacle, other uses are contemplated as well such as use for trash with the additional feature of hardware to enable trash compaction.

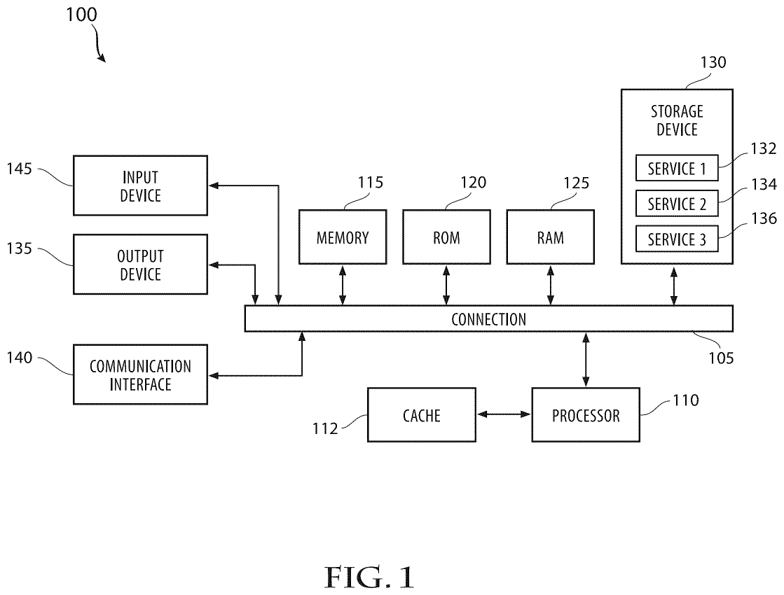

A system, method and computer-readable media are disclosed which enable management of a plurality of receptacles in a neighborhood including access rights for citizens or enrollees of a program to enable individuals to access the receptacles. A brief introductory description of a basic general purpose system or computing device in FIG. 1, which can be employed to practice the concepts, is disclosed herein. A more detailed description and variations of electrically-powered receptacles, as well as systems for managing access to the receptacles will then follow. These variations shall be described herein as the various aspects are set forth.

With reference to FIG. 1, an exemplary system and/or computing device 100 includes a processing unit (CPU or processor) 120 and a system bus 110 that couples various system components including the system memory 130 such as read only memory (ROM) 140 and random access memory (RAM) 150 to the processor 120. The system 100 can include a cache 122 of high-speed memory connected directly with, in close proximity to, or integrated as part of the processor 120. The system 100 copies data from the memory 130 and/or the storage device 160 to the cache 122 for quick access by the processor 120. In this way, the cache provides a performance boost that avoids processor 120 delays while waiting for data. These and other modules can control or be configured to control the processor 120 to perform various operations or actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general-purpose processor and a hardware module or software module, such as module 1 162, module 2 164, and module 3 166 stored in storage device 160, configured to control the processor 120 as well as a special-purpose processor where software instructions are incorporated into the processor. The processor 120 may be a self-contained computing system, containing multiple cores or processors, a bus, memory controller, cache, etc. A multi-core processor may be symmetric or asymmetric. The processor 120 can include multiple processors, such as a system having multiple, physically separate processors in different sockets, or a system having multiple processor cores on a single physical chip. Similarly, the processor 120 can include multiple distributed processors located in multiple separate computing devices, but working together such as via a communications network. Multiple processors or processor cores can share resources such as memory 130 or the cache 122, or can operate using independent resources. The processor 120 can include one or more of a state machine, an application specific integrated circuit (ASIC), or a programmable gate array (PGA) including a field PGA.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 or computer-readable storage media such as a hard disk drive, a magnetic disk drive, an optical disk drive, tape drive, solid-state drive, RAM drive, removable storage devices, a redundant array of inexpensive disks (RAID), hybrid storage device, or the like. The storage device 160 can include software modules 162, 164, 166 for controlling the processor 120. The system 100 can include other hardware or software modules. The storage device 160 is connected to the system bus 110 by a drive interface. The drives and the associated computer-readable storage devices provide nonvolatile storage of computer-readable instructions, data structures, program modules and other data for the computing device 100. In one aspect, a hardware module that performs a particular function includes the software component stored in a tangible computer-readable storage device in connection with the necessary hardware components, such as the processor 120, bus 110, display 170, and so forth, to carry out a particular function. In another aspect, the system can use a processor and computer-readable storage device to store instructions which, when executed by the processor, cause the processor to perform operations, a method or other specific actions. The basic components and appropriate variations can be modified depending on the type of device, such as whether the device 100 is a small, handheld computing device, a desktop computer, or a computer server. When the processor 120 executes instructions to perform “operations”, the processor 120 can perform the operations directly and/or facilitate, direct, or cooperate with another device or component to perform the operations.

Although the exemplary aspect(s) described herein employs the hard disk 160, other types of computer-readable storage devices which can store data that are accessible by a computer, such as magnetic cassettes, flash memory cards, digital versatile disks (DVDs), cartridges, random access memories (RAMs) 150, read only memory (ROM) 140, a cable containing a bit stream and the like, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic hardware depicted may easily be substituted for improved hardware or firmware arrangements as they are developed.

In one aspect, the communications interface 180 can encompass technology for enabling cellular communication, WiFi communication or other forms of communication. For example, a near-field communication (NFC) component can be included in the communications interface 180 which enables near field or short distance electronic communication with an NFC tag. The communications interface 180 can include a component to communicate using Bluetooth or any other communication protocol. An RFID reader can be included in the communications interface 180 for receiving a radio frequency signal from a user device.

For clarity of explanation, the illustrative system aspect is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general-purpose processor. For example, the functions of one or more processors presented in FIG. 1 may be provided by a single shared processor or multiple processors. (Use of the term “processor” should not be construed to refer exclusively to hardware capable of executing software.) Illustrative aspects may include microprocessor and/or digital signal processor (DSP) hardware, read-only memory (ROM) 140 for storing software performing the operations described below, and random access memory (RAM) 150 for storing results. Very large scale integration (VLSI) hardware aspects, as well as custom VLSI circuitry in combination with a general purpose DSP circuit, may also be provided.

The logical operations of the various aspects are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited tangible computer-readable storage devices. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored in other computer-readable memory locations.

One or more parts of the example computing device 100, up to and including the entire computing device 100, can be virtualized. For example, a virtual processor can be a software object that executes according to a particular instruction set, even when a physical processor of the same type as the virtual processor is unavailable. A virtualization layer or a virtual “host” can enable virtualized components of one or more different computing devices or device types by translating virtualized operations to actual operations. Ultimately however, virtualized hardware of every type is implemented or executed by some underlying physical hardware. Thus, a virtualization compute layer can operate on top of a physical compute layer. The virtualization compute layer can include one or more of a virtual machine, an overlay network, a hypervisor, virtual switching, and any other virtualization application.

The processor 120 can include all types of processors disclosed herein, including a virtual processor. However, when referring to a virtual processor, the processor 120 includes the software components associated with executing the virtual processor in a virtualization layer and underlying hardware necessary to execute the virtualization layer. The system 100 can include a physical or virtual processor 120 that receive instructions stored in a computer-readable storage device, which cause the processor 120 to perform certain operations. When referring to a virtual processor 120, the system also includes the underlying physical hardware executing the virtual processor 120.

The computing system 100 can be used in one or more components disclosed such as a network server, a storage device, a mobile user device. The “system” can include any one or more of these components that perform their respective functions in order to enable improved composting as described herein.

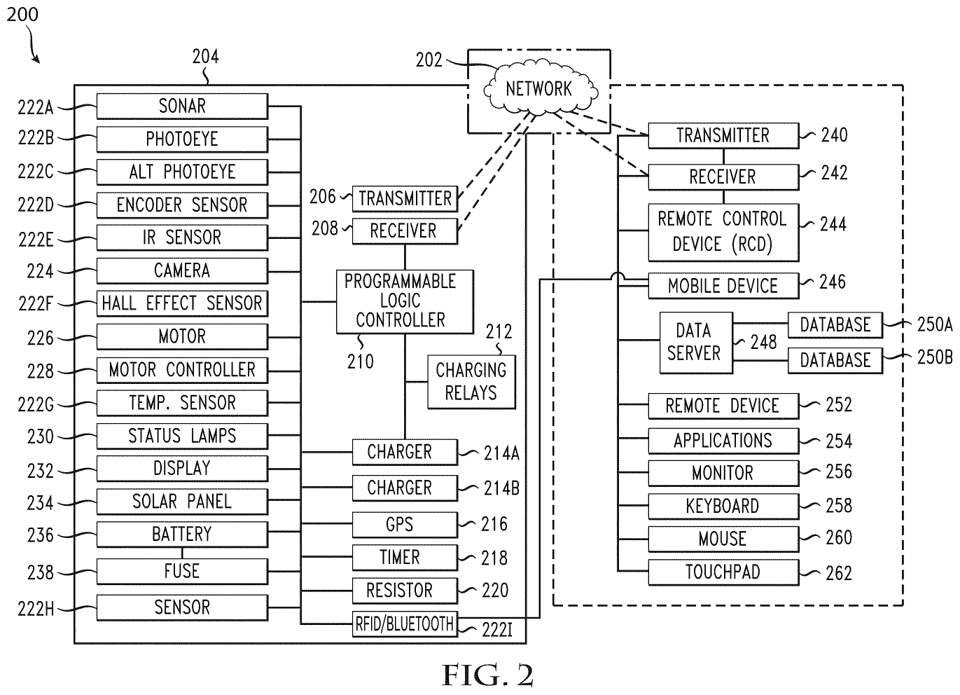

Having disclosed some components of a computing system, the disclosure now turns to FIG. 2, which illustrates an exemplary architecture for controlling electrically-powered compactors or compost receptacles both locally and remotely via a network. Receptacle 204 can be an electrically-powered receptacle for collecting waste, such as waste food, trash or recyclables, for example. As illustrated, receptacle 204 can be, for example, a solar, wind, geo-thermal, or battery-powered receptacle and/or compactor. The receptacle 204 can be a compost receptacle configured to receive compost or waste food and can be solar-powered. Preferably, the receptacle 204 can recharge while in an inactive state. Moreover, receptacle 204 can include a motor 226 for performing various operations, such as compaction or other operations related to composting. In general, the system in FIG. 2 will include control to utilize power in the battery 236 to run a motor 226 that performs compaction on the trash within a bin inside the receptacle or any other compost related operations. Further, receptacle 204 can be remotely controlled via remote control device (RCD) 244. The RCD can be another node in a mesh network or can be a controlling device which is not a node. To this end, receptacle 204 can include transmitter 206 and receiver 208 for communicating with RCD 244. In particular, transmitter 206 and receiver 208 can communicate with transmitter 240 and receiver 242 on RCD 244, and vice versa.

Here, transmitters 206 and 240 can transmit information, and receivers 208 and 242 can receive information, such as control information. This way, receptacle 204 and RCD 244 can be connected to transmit and receive information, such as instructions, commands, statistics, alerts, notifications, files, software, data, and so forth. Receptacle 204 can also communicate with other devices, such as a server and/or a collection vehicle, via transmitter 206 and receiver 208. Similarly, RCD 244 can communicate with other devices, such as a server and/or a user device 246, 252, via transmitter 240 and receiver 242. For example, the receptacle can transmit to a network device information such as who has accessed the receptacle 204, at what time did an individual access the receptacle 204, how much waste food or other items did they place in the receptacle 204, and a status of a fullness level of the receptacle 204 which can relate to a collection schedule.

Moreover, receptacle 204 and RCD 244 can communicate with each other and/or other devices via network 202. The network 202 can include a public network, such as the Internet, but can also include a private or quasi-private network, such as an intranet, a home network, a virtual private network (VPN), a shared collaboration network between separate entities, etc. Indeed, the network 202 can include many types of networks, such as local area networks (LANs), virtual LANs (VLANs), corporate networks, wide area networks, a cell phone transmitter and receiver, a WiFi network, a Bluetooth network, and virtually any other form of network.

Transmitter 206 and receiver 208 can be connected to printed circuit board (PCB) 210, which controls various functions on receptacle 204. In some aspects, the RCD 244 can be incorporated within the PCB 210. In FIG. 2, the RCD 244 is electrically connected to the PCB 210 via transmitters 206, 240 and receivers 208, 242. The RCD 244 can be connected to transmitter 240 and receiver 242 via a two-way communication port, which includes transmitter 240 and receiver 242. The PCB 210 can control electrical functions performed by the receptacle 204. Electrical functions can include, for example, running compactions by actuating a motor 226; sensing waste object, waste food, or recyclables volume inside the receptacle 204 using a sensor at regular or programmable intervals, such as a sonar-based sensor 222A, a proximity sensor or other sensor 222H, and/or photoeye sensors 222B-C; changing status lamps 230 at regular and/or programmable thresholds to/from a color indicating that the receptacle 204 is not full (e.g., green), to/from a color indicating that the receptacle 204 is almost full (e.g., yellow), to/from a color indicating that the receptacle 204 is full (e.g., red); etc.

The RCD 244 can enable remote control and/or alteration of the functions performed or operated by the PCB 210, including placing the receptacle 204 in an active and/or passive state. The RCD 244 can also provide access to, and control over, the various components 206, 208, 210, 212, 214A-B, 216, 218, 220, 222A-I, 224, 226, 228, 230, 232, 234, 236, 238 of the receptacle 204. Users can use a networked device, such as smartphone 246 and/or remote device 252, to communicate with the RCD 244 in order to manage and/or control the receptacle 204. For example, a user can communicate with the RCD 244 via the remote device 252 to change a threshold value on the PCB 210, which can control, for example, a collection timing; the compaction motor 226; the use of energy on a lighted advertising display, such as display 232; the status lamps 230; the sensors 222A-H; the camera 224; etc. The remote device 252 can include virtually any device with networking capabilities, such as a laptop, a portable media player, a tablet computer, a gaming system, a smartphone, a global positioning system (GPS), a smart television, a desktop, etc. In some aspects, the remote device 252 can also be in other forms, such as a watch, imaging eyeglasses, an earpiece, etc.

The remote device 252 and RCD 204 can be configured to automatically modify the PCB's 210 operating parameters. However, users can also manually modify the PCB's 210 operating parameters via the remote device 252 and RCD 204. The operating parameters can be modified in response to, for example, evolving industry benchmarks; user inputs; historical data, such as the data gathered from a separate database 250A-B; forecasted data, such as upcoming weather characteristics; traffic conditions; a collection schedule; a collection route; a proximity of a collection vehicle; a time and/or date; a location; a capacity, such as a capacity of the receptacle 204 and/or a capacity of a collection vehicle; a fullness state of the receptacle 204; lapsed time between collections; lapsed time between compactions; usage conditions of the receptacle 204; energy usage; battery conditions; statistics; a policy; regulations; a detected movement of an object, such as an object inside or outside of the receptacle 204; collection trends; industry and/or geographical standards; zoning policies and characteristics; real-time information; user preferences; and other data. The data from the remote device 252 can be relayed to the RCD 244, and the data from the RCD 244 can be relayed, via the network 202, to the receptacle 204 and/or the remote device 252 for presentation to the user.

The user can control the RCD 244 and/or access and modify information on the RCD 244 via a user interface, such as a web page, an application 254, a monitor 256, and/or via voice messages and commands, text messages, etc. The remote device 252 can include a user interface, which can display, for example, graphs of collection statistics and trends (e.g., collection frequency, usage, temperature, etc.), collection reports, device settings, collection schedules, collection configurations, historical data, status information, collection policies, configuration options, device information, collection routes and information, alerts, etc. This way, users can access information to make educated decisions about how to set and/or reset operating parameters on the PCB 210; to control, for example, which sensors are used to gather data, which thresholds to set; to control outputs from the status lamps 230 and other components; etc. User can change settings on the receptacle 204, such as optimal collection timing, timing of sensor actuation; and/or modify parameters, such as desired capacity and fullness thresholds; using a scroll down menu, click-and-slide tools, interactive maps displayed on the remote device 252, touch screens, forms, icons, text entries, audio inputs, text inputs, etc. In response, the RCD 244 can automatically reconfigure the PCB 210 settings, recalibrate sensors and displays, change operating parameters, etc.

The RCD 244 can include a two-way communication port that includes transmitter 240 and receiver 242, which can wirelessly communicate with the PCB 210 of the receptacle 204, via the transmitter 206 and receiver 208 on the receptacle 204, which are connected electrically to the PCB 210. On scheduled and/or programmable intervals, the PCB's 210 transmitter 206 can send data to a central server, such as data server 248, via the network 202. The same transmitter 206 and receiver 208 can be used to communicate with other nodes (whether receptacles, benches, or other public objects) in a mesh network. Moreover, the RCD's 244 receiver 242 can be configured to query the data server 248, which can also be connected to the remote device 252, for incoming data. The data server 248 can communicate data from databases 250A-B. If there is no data to be received by the receiver 208, the PCB 210 can be configured to promptly return to a low-power mode, where the transmitter 206 and receiver 208 circuits are turned off, until another scheduled, received, initiated, and/or programmed communication event. Such a low-power mode can be the same as an “inactive” mode, or can be distinct from an “inactive” mode because the sensor/transmitter being used are distinct from the transmitter 206 and receiver 208. If there is data to be received by the receiver 208, such as a command to turn the receptacle 204 off and then back on, a command to change the thresholds upon which compactions are operated, a command to change the thresholds for providing status updates and/or determining fullness states, etc., then the RCD receiver 242 can download the new data from the data server 248, via the RCD 244, to the PCB 210, altering its operating configuration. The RCD receiver 242 can also be configured to send data to the data server 248 to acknowledge the receipt of data from the PCB 210, and to send selected data to the remote device 252, the smartphone 246, and/or any other device, for presentation to a user.

The data server 248 can also display the data to a user on remote device 252, smartphone 246, or any other device. The data can be a password-protected web page, a display on the smartphone 246, a display on the monitor 256, etc. Remote control using the RCD 244 to reconfigure operating thresholds, sensor use, sensor hierarchy, energy usage, etc., can enable the receptacle 204 to alter characteristics that control its energy generation, energy consumption, and/or the collection and management logistics, further enabling sound operation of the receptacle 204.

The RCD 244 can be configured to communicate over a wireless network with the PCB 210, and transmit data to the data server 248, so the data can be stored for viewing and manipulation by a user via any web-connected computer, phone, or device. The RCD 244 can also be configured to receive data from the data server 248 and transmit the data back to the PCB 210. The PCB 210 can be electrically connected to a variety of sensors, such as sensors 222A-H, within the receptacle 204. Through the RCD 244, the PCB 210 can also be wirelessly connected to the databases 250A-B, and/or other external databases, such as a weather database, which may, for example, reside on a National Oceanographic and Atmospheric (NOAA) server, a database of trucks and locations and schedules, which may reside on a waste hauler's server, a database of traffic conditions, etc. A user can also change which of the sensors 222A-H are used in setting thresholds, among other things, in response to, for example, user commands and/or changes in outside data, such as weather data or truck location data.

The PCB 210 can also communicate with a temperature sensor 222G to gather temperature information, which can be transmitted to the RCD 244 via the PCB transmitter 206. The temperature information can be used, among other things, to fine tune operational functions and energy consumption of the receptacle 204. For example, the PCB 210 can be reconfigured to run less compaction per day, such as four to eight compactions, in cold weather, since batteries are less powerful in cold weather. Coinciding with cold weather, the winter days are shorter, thus solar energy and battery power is limited. In order to conserve power on low-sunlight days, the RCD 244 can adjust the PCB's 210 normal fullness sensitivity levels, so that collections are prompted to be made earlier. For example, if the PCB 210 typically runs 20 compactions before changing status lamps from green to yellow, a signal that suggests optimal collection time, the RCD 244 can adjust the thresholds of the PCB 210 to run 10 compactions before changing from a green state to a yellow state, thus changing the total energy consumption of the compactor between collections. In a busy location, the PCB 210 can be configured to sense receptacle fullness every minute, whereas in a less busy location, the PCB 210 can be configured to sense fullness once a day.

In some aspects, the RCD 244 can also alter the timing of events using algorithms based on the results of historical events. For example, the RCD 244 can be initially configured to sense fullness once per minute, but based on resulting readings, it can then alter the timing of future readings. Thus, if three consecutive readings taken at one-minute intervals yield a result of no trash accumulation, the RCD 244 can increase the timing between readings to two minutes, then three minutes, etc., based on the various readings. The RCD 244 can also be configured to adjust sensing intervals based on the level of fullness of the receptacle 204, so it would sense more frequently as the receptacle 204 fills, in order to reduce the margin of error at a critical time, before the receptacle 204 overflows. This “learning feature” can save energy by ultimately synchronizing the sensor readings with actual need to sense. The RCD 244 can also alter thresholds of status lamps 230 based on collection history, the need for capacity as determined by the frequency of red or yellow lights on the receptacle 204, temperatures, expected weather and light conditions, expected usage conditions, etc. The status lamps 230 can be LED lights, for example.

In FIG. 2, the RCD 244 can be enabled, via the PCB 210, to read, for example, a temperature sensor 222G; an encoder sensor 222D, which can measure movement of a compaction ram by utilizing an “encoder wheel” which is mounted on a motor shaft; one or more photoeye sensors 222B-C; door sensors; a sensor which measures current from the solar panel and a sensor which can measure current from the battery 236 to the motor 226; a hall effect sensor 222F, which can detect movement of, for example, a door; an infrared (IR) sensor 222E, a camera 224, etc. In addition, the thresholds set by the RCD 244 can be based on historical and real-time information, user preferences, industry norms, weather patterns and forecasts, and other information. The RCD 244 can reset the PCB's 210 normal thresholds hourly, daily, weekly, monthly, yearly, or at adjustable intervals, based on a variety of information and user decisions.

The RCD 244 can also alter the PCB's 210 normal hierarchy of sensor usage. For example, if the PCB 210 is configured to run a compaction cycle when one or more of the photoeyes 222B-C located inside the receptacle 204 are blocked, the RCD 244 can reconfigure the sensor hierarchy by reconfiguring the PCB 210 to run compaction cycles after a certain amount of time has passed, by reading the position of the encoder sensor 222D at the end of a cycle, by reading one or more photoeye sensors 222B-C, by calculating a sensor hierarchy based on historical filling rates, by a change in user preferences, etc. Using an aggregate of data from other receptacles located worldwide in a variety of settings, the RCD's 244 configurations can depend on constantly evolving parameters for optimizing energy utilization, capacity optimization, and operational behavior, among other things. The RCD 244 innovation and growing database of benchmarks, best practices and solutions to inefficiency, enables the receptacle 204 to adapt and evolve.

Based on the data from the PCB 210, the sensors, inputs by the users (e.g., the customer or the manufacturer) via the RCD 244, and/or based on other data, such as historical or weather data, the RCD 244 can change the PCB 210 thresholds, operational parameters, and/or configuration, to improve the performance of the receptacle 204 in different geographies or seasons or based on different user characteristics or changing parameters. Thus, the system and architecture can be self-healing.

The RCD 244 can also be configured to change the PCB's 210 normal operating parameters. For example, the RCD 244 can be configured to cause the PCB 210 to run multiple compaction cycles in a row, to run energy through a resistor 220 to apply a strong load upon the battery 236, which can supply the energy. The RCD 244 can measure battery voltage at predetermined or programmable intervals, to measure the “rebound” of the battery 236. A strong battery will gain voltage quickly (e.g., the battery will almost fully recover within 15 minutes or so). A weak battery will drop significantly in voltage (e.g., 3-5 volts), will recover slowly, or will not recover to a substantial portion of its original voltage. By changing the normal parameters of the PCB 210, the battery 236 can be subjected to a heavy load during a test period, which will determine the battery's strength without jeopardizing operations. The RCD 244 can then be configured to relay a message to the user that a battery is needed, or to use the battery differently, for example, by spacing out compactions in time, reducing the degree of voltage decline within a certain time period, etc. Based on the message and any additional information from the RCD 244, the user can then order a new battery by simply clicking on a button on a web page, for example. The RCD 244 can also alter the PCB 210 to do more compactions or other energy-using functions (like downloading software) during the daytime, when solar energy is available to replenish the battery 236 as it uses energy.

Since the RCD 244 can be connected to databases and can be informed by the PCB 210 on each receptacle of conditions or status information at the respective receptacle, the RCD 244 can also be used to relay data collected from the databases or PCB 210 for other types of servicing events. In other words, the RCD 244 can obtain, collect, maintain, or analyze status, operating, or conditions information received from the PCB 210 of one or more receptacles and/or one or more databases storing such information, and relay such data to a separate or remote device, such as a remote server or control center. For example, the RCD 244 can be configured to relay a message to a waste hauler to collect the receptacle 204 if two or more parameters are met simultaneously. To illustrate, the RCD 244 can relay a message to a waste hauler to collect the receptacle 204 if the receptacle 204 is over 70% full and a collection truck is within 1 mile of the receptacle 204. The RCD 244 can then send a message to the remote device 252 to alert a user that a collection had been made, and the cost of the collection will be billed to the user's account.

In addition, the RCD 244 can change the circuitry between the solar panel 234 and the battery 236, so that solar strength can be measured and an optimal charging configuration can be selected. The charging circuitry 214A-B is illustrated as two circuitries; however, one of ordinary skill in the art will readily recognize that some aspects can include more or less circuitries. Charging circuits 214A-B can be designed to be optimized for low light or bright light, and can be switched by the RCD 244 based on programmable or pre-determined thresholds. Also, while solar information can be readily available (e.g., Farmers' Almanac), solar energy at a particular location can vary widely based on the characteristics of the site. For example, light will be weaker if reflected off a black building, and if the building is tall, blocking refracted light. For this reason, it can be useful to measure solar energy on site, as it can be an accurate determinant of actual energy availability at a particular location. To do this, the battery 236 and solar panel 234 can be decoupled using one or more charging relays 212. In other aspects, a very high load can be placed on the battery 236 to diminish its voltage, so that all available current from the solar panel 234 flows through a measureable point. This can be done, for example, by causing the receptacle 204 to run compaction cycles, or by routing electricity through a resistor, or both.

There are a variety of other methods which can be used to create a load. However, putting a load on the battery 236 can cause permanent damage. Thus, the RCD 244 can also be configured to disconnect the battery 236 from the solar panel 234, instead routing electricity through a resistor 220. This can allow for an accurate measurement of solar intensity at a particular location, without depleting the battery 236, which can help assess the potential for running compactions, communicating, powering illuminated advertisements, and powering other operations. In some aspects, the PCB 210 can be reconfigured by the RCD 244 to run continuous compaction cycles for a period of time, measure solar panel charging current, relay the data, and then resume normal operations. Different configurations or combinations of circuits can be used to test solar intensity, battery state or lifecycle, and/or predict solar or battery conditions in the future.

The RCD 244 can also track voltage or light conditions for a period of days and alter the state of load and charging based on constantly changing input data. For example, the RCD 244 can configure the timer 218 of the PCB 210 to turn on the display 232 for advertising for a number of days in a row, starting at a specific time and ending at another specific time. However, if the battery voltage declines over this period of time, the RCD 244 can then reduce the time of the load (the display 232) to every other day, and/or may shorten the time period of the load each day. Further, the RCD 244 can collect information on usage and weather patterns and reconfigure the PCB's 210 normal operating regimen to increase or reduce the load (for example, the advertisement on the display 232) placed on the battery 236, based on the information collected. For example, if it is a Saturday, and expected to be a busy shopping day, the RCD 244 can allow a declining state of the battery 236 and can schedule a period on the near future where a smaller load will be placed on the battery 236, by, for example, not running the advertisement on the coming Monday. In doing so, the RCD 244 can optimize the advertising value and energy availability to use energy when it is most valuable, and recharge (use less energy) when it is less valuable. In order to maximize solar energy gained from a variety of locations, the RCD 244 can cause the PCB 210 to select between one of several charging circuits. For example, if it is anticipated that cloudy conditions are imminent, the RCD 244 can change the circuit that is used for battery charging, in order to make the charger more sensitive to lower light conditions. In a sunny environment, the charger circuit used can be one with poor low-light sensitivity, which would yield more wattage in direct sunlight.

The current application for the receptacle 204 can include a composting function as noted above. A radio frequency identification (RFID), Bluetooth module, near-field communication (NCF) or other communication module 222I can be provided as well in the receptacle 204. As described herein, a user can sign up for a program to enable them to use a mobile device (such as smartphone or mobile device 246) or an RFID, a key fob or other device (also represented as feature 246) to unlock a lockable hopper and provide composting material into the receptacle 204. Feature 222I can represent any wireless communication component which can interact with or receive a signal from a mobile device 246 which can cause the hopper to unlock. Feature 222I can also represent a graphical image such as QR (quick response) Code that can enable a user to receive a URL (universal resource locator) and access a server and receive an App Clip or a user interface and enable them to either sign up, pay or otherwise interact with the system to obtain access to the receptacle 204 by unlocking the hopper 306. App Clips were developed by Apple Inc. and is a small part of an application that lets the user do a task quickly, like rent a bike, pay for parking, or order food. The App Clip can be downloaded in connection with an interaction with an NFC tag a QR code. The App Clip Code (i.e., the visual object that can be scanned or an electronic object like an NFC tag) can be a unique marker that can transition the user to receive a specific App Clip for performing a task. In this case, the App Clip can provide functionality to enable the user to unlock the receptacle 204. The task might include one or more of a payment (which can be made through the App Clip via Apple Pay, Google Pay, PayPal or some other payment mechanism), or an identification of the person, or enable them to sign up for the program, or use the receptacle 204 as “guest” user from a different city and so forth.

The user who is granted access to the receptacle 204 can receive via the network 202 an assignment of a time and a location for dropping off compost when the receptacle 204 is used for composting. For example, the receptacle 204 can be configured to give access to the user via use of their mobile device 246 or other device for one hour between 3 PM and 4 PM for dropping of compost. A network server as introduced later can manage the timing and location for user assignments to drop of compost.

The architecture 200 can also be used for monitoring functions, which can enable users to access information about the receptacle 204 and collection process. With this information, users can make judgments that facilitate their decision-making, helping them remotely adjust settings on the receptacle 204 to improve performance and communication. For example, the RCD 244 can be configured to enable users to easily adjust callback time, which is the normal time interval for communication that is configured in the PCB 210. The RCD 244 can enable the user to alter this time setting, so that the receptacle 204 communicates at shorter or longer intervals. Once the PCB 210 initiates communication, other parameters can be reconfigured, such as awake time, which is the amount of time the receiver is in receiving mode. This enables users to make “on the fly” changes. In some cases, the PCB 210 can shut down after sending a message and listening for messages to be received. In these cases, it can be difficult to send instructions, wait for a response, send more instructions and wait for response, because the time lapse between normal communications can be a full day. However, by remotely adjusting the setting through the RCD 244, the user can make continuous adjustments while testing out the downloaded parameters in real time, and/or close to real time. This can enhance the ability of the user to remotely control the receptacle 204.

Further, the RCD 244 can alter the current of the photoeyes 222B-C, in a test to determine whether there is dirt or grime covering the lens. Here, the RCD 244 can reconfigure the normal operating current of the photoeyes 222B-C. If the lens is dirty, the signal emitter photoeye will send and the signal receiver will receive a signal on high power, but not on low power. In this way, a service call can be avoided or delayed by changing the normal operating current to the photoeyes 222B-C. This can be a useful diagnostic tool.

In some aspects, regular maintenance intervals can be scheduled, but can also be altered via information from the RCD 244. The RCD 244 can be configured to run a cycle while testing motor current. If motor current deviates from a normal range (i.e., 2 amps or so), then a maintenance technician can be scheduled earlier than normal. The RCD 244 can send a message to the user by posting an alert on a user's web page or graphical interface on a mobile device 246 associated with the receptacle 204. The user in this case can be a technician or person who is to empty a receptacle or can be a member of the public who is using the receptacle 204.

Other settings can be embodied in the receptacle 204 as well. For example, the PCB 210 can sense that the receptacle 204 is full. The RCD 244 can then configure the PCB 210 to have a web page, or another display, present a full signal. The RCD 244 can alter when the full signal should be presented to the user. For example, after accessing a database with historical collection intervals, the RCD 244 can reconfigure the PCB 210 to wait for a period of time, e.g., one hour, before displaying a full signal at the web page. This can be helpful because, in some cases, a “false positive” full signal can be signaled by the PCB 210, but this can be avoided based on historical information that indicates that a collection only a few minutes after the last collection would be highly aberrational. The RCD 244 can thus be configured to override data from the PCB 210. Instead of sending a full signal to the user, the RCD 244 reconfigures the PCB 210 to ignore the full signal temporarily, and delay the display of a full-signal on the users' web page or smart phone, in order for time to go by and additional information to be gathered about the receptacle's actual fullness status. For example, when a collection is made and ten minutes later, the fullness sensor detects the receptacle 204 is full, the fullness display message on the web page can be prevented from displaying a full status. In some cases, the bag can be full of air, causing the proximity sensor in the receptacle 204 to detect a full bin. Within a certain time period, e.g., twenty minutes in a busy location, a few hours in a less busy location, as determined based on the historical waste generation rate at the site, the bag can lose its air, and the proximity sensor can sense that the bin is less full than it was twenty minutes prior, which would not be the case if the bin was full with trash instead of air. Thus, “false positive” information can be filtered out.

Tests and checks can be performed so that false negative information is avoided as well. For example, if a bin regularly fills up daily, and there is no message that it is full after two or three days, an alert can appear on the users' web page indicating an aberration. Thresholds for normal operating parameters and adjustments to normal can be set or reset using the RCD 244, or they can be programmed to evolve through pattern recognition. Although many operating parameter adjustments can be made through the web portal, adjustments can also be made automatically. This can be controlled by a software program that aggregates data and uses patterns in an aggregate of enclosures to alter PCB 210 settings on a single enclosure. For example, if the collection data from 1,000 enclosures indicates that collection personnel collect from bins too early 50% of the time when compaction threshold setting is set to “high”, compared to 10% of the time when compaction settings are set at “medium,” then the RCD 244 can reprogram the compaction thresholds to the medium setting automatically, so that collection personnel can be managed better, limiting the amount of enclosures that are collected prematurely. Automatic reprogramming, governed by software programs, can be applied to other aspects, such as user response to dynamic elements of the receptacle 204, such as lighted or interactive advertising media displayed on the receptacle 204. For example, if users respond to an LCD-displayed advertisement shown on the receptacle 204 for “discounted local coffee” 80% of the time, the RCD 244 can configure all receptacles within a certain distance, from participating coffee shops, to display the message: “discounted local coffee.”

In some aspects, the RCD 244 can include a data receiving portal for the user with information displays about an aggregate of receptacles. Here, the user can access real-time and historical information of, for example, receptacles on a route, and/or receptacles in a given geography. The data can be displayed for the user on a password-protected web page associated with the aggregate of receptacles within a user group. The receptacle 204 can also display, for example, bin fullness, collections made, the time of collections, battery voltage, motor current, number and time of compaction cycles run, graphs and charts, lists and maps, type of compost, scheduled pickup times, scheduled user drop off time and/or receptacle locations for compost, etc. The data can be viewed in different segments of time and geography in order to assess receptacle and/or fleet status, usage, user drop-off assignment schedules for compost, and/or trends. The users' web page can illustrate, for example, a pie chart showing percentage of bins collected when their LED was blinking yellow, red and green, or a histogram showing these percentages as a function of time. These statistics can be categorized using pull down menus and single-click features. A single click map feature, for example, is where summary data for a particular receptacle is displayed after the user clicks on a dot displayed on a map which represents that receptacle. This can allow the user to easily view and interact with a visual map in an external application.

The RCD 244 can be configured to display calculated data, such as “collection efficiency,” which is a comparison of collections made to collections required, as measured by the utilized capacity of the receptacle 204 divided by the total capacity of the receptacle 204 (Collection Efficiency=utilized capacity/total capacity). The user can use this information to increase or decrease collections or waste or compost, increase or decrease the aggregate capacity across an area, etc. Typically, the users' goal is to collect the receptacle 204 when it is full—not before or after. The user can click buttons on their web page to show historical trends, such as collection efficiency over time, vehicle costs, a comparison of vehicle usage in one time period versus vehicle usage in another time period, diversion rates, a comparison of material quantity deposited in a recycling bin versus the quantity of material deposited into a trash bin or for composting. Other statistics can be automatically generated and can include carbon dioxide emissions from trucks, which can be highly correlated to vehicle usage or statistics regarding user compost drop off rates or rates of users following compost drop off instructions or schedules. Labor hours can also be highly correlated with vehicle usage, so the web page can display a labor cost statistic automatically using information generated from the vehicle usage monitor. As the user clicks on buttons or otherwise makes commands in their web portal, the RCD 244 can change the PCB's 210 operating parameters, usage of sensors, etc., and/or measurement thresholds in response. The RCD 244 can also be configured to automatically display suggested alterations to the fleet, such as suggestions to move receptacles to a new position, to increase or decrease the quantity of receptacles in a given area, to recommend a new size receptacle based on its programmed thresholds, resulting in an improvement in costs to service the fleet of receptacles.

Receptacles 204 disclosed herein can include both regular waste and composting receptacles. The pickup schedules or pickup vehicles can be modified to have a portion configured to receive regular waste and a portion to receive composting waste. A pickup schedule or route can take these two different kinds of materials into account when scheduling or assignment a pickup of a group of receptacles.

Heat mapping can also be used to provide a graphical representation of data for a user. Heat mapping can show the user the level of capacity in each part of an area, for example a city block, or it can be used to show collection frequency in an area. In each case, the heat map can be generated by associating different colors with different values of data in a cross sectional, comparative data set, including data from a plurality of enclosures or from different types of receptacles such as regular waste and compost waste. The heat map can be a graphical representation of comparative data sets. In some aspects, red can be associated with a high number of a given characteristic, and “cooler” colors, like orange, yellow and blue, can be used to depict areas with less of a given characteristic. For example, a heat map showing collection frequency, use frequency for composting or compaction frequency across 500 receptacles can be useful to determine areas where capacity is lacking in the aggregate of enclosures—a relative measure of capacity. In one aspect, the highest frequency receptacle can be assigned a value of red. Each number can be assigned progressively cooler colors.

In other aspects, the red value can be associated with a deviation from the average or median, for example, a darker red for each standard deviation. The heat maps can be shown as a visual aid on the user's web page, and can color-code regions where “bottlenecks” restrict vehicle and labor efficiency. A small red region can show graphically, for example, that if the user were to replace only ten receptacles with higher-capacity compactors, the collection frequency to a larger area could be reduced, saving travel time. Heat maps can be a helpful visual tool for showing data including, but not limited to, data showing “most collections” in a given time period, “most green collections,” which can visually demonstrate the number of bins collected too early (before they are actually full), “most compactions,” which can show on a more granular level the usage level of the bin, “most uses,” which can represent how many times the insertion door of the bin is opened or utilized, “most alerts,” which can show visually the number of “door open alerts,” which can show when doors were not closed properly, “voltage alerts,” which can show visually which receptacles are of low power, etc. While specific measurements are described herein to demonstrate the usefulness of heat mapping, there are other sets of data that can be represented by the heat maps, which are within the scope and spirit of this invention.

The heat map can also be used to present a population density in one or more areas, as well as a representation of any other activity or characteristic of the area, such as current traffic or congestion, for example. This information can also be shared with other businesses or devices. For example, the RCD 244 can analyze the heat map and share population statistics or activity with nearby businesses or municipalities. The RCD 244 can, for example, determine a high population density in Area A on Saturday mornings and transmit that information to a nearby locale to help the nearby locale prepare for the additional activity. As another example, if the receptacle 204 is placed in a park, the RCD 244 can determine population and activity levels at specific times and alert park officials of the expected high levels of activity so the park officials and/or those managing the receptacle 204 can plan accordingly.

The RCD 244 can also be used for dynamic vehicle routing and compaction and/or receptacle management. Because the RCD 244 can be a two-way communicator, it can both send and receive information between various receptacles and databases, using a mesh network. This can allow the user to cross-correlate data between the fleet of receptacles and the fleet of collection vehicles. The RCD 244 can receive data from the user and/or the user's vehicle. For example, the RCD 244 can receive GPS data or availability data and use it to change parameters on a given receptacle or aggregate of receptacles. The RCD 244 can receive this data from the users' GPS-enabled smartphone, for example. Similarly, the RCD 244 can send data to the user, a user device, a smartphone, etc., about the status of the receptacle 204. With this two-way data stream, collection optimization can be calculated in real time or close to real time. For example, a collection truck is traveling to the east side of a city and has 30 minutes of spare time. The RCD 244 can receive information about the truck's whereabouts, availability and direction, and query a database for receptacle real time and historical fullness information and determine that the truck can accommodate collections of twenty receptacle locations. The RCD 244 can then display a list of twenty receptacle locations that the truck can accommodate. The user can view a map of the twenty recommended locations, see a list of driving directions, etc. The map of driving directions can be optimized by adding other input data, such as traffic lights, traffic conditions, average speed along each route, etc. At the same time, as the truck heads to the east side of the city, the RCD 244 can reconfigure receptacles on the west side to change compaction thresholds, so that capacity is temporarily increased, freeing up additional time for the truck to spend in the east section. Alternatively, the RCD 244 can reconfigure a receptacle to temporarily display a “full” message to pedestrians, helping them find a nearby receptacle with capacity remaining. The RCD 244 can, in the case where the receptacle requires payment, increase pricing to the almost-full receptacle, reducing demand by pedestrians or other users. This same logic can be effective in situations where trucks are not used, for example, indoors at a mall or airport. The demand for waste capacity can vary, so having remote control over the receptacle 204 can allow users to change settings, parameters, and/or prices to make the collection of waste dynamic and efficient.

The location of the receptacle 204 and other receptacles can be determined via triangulation and/or GPS, for example, and placed on a map in the interactive mapping features. Moreover, the location of an indoor receptacle can be obtained from indoor WiFi hot spots, and the indoor receptacle can be placed on a map in the interactive mapping features. As a staff member accomplishes tasks (i.e., cleaning a bathroom) and moves inside a facility, the staff member's location can be tracked, and the fullness and location of nearby receptacles can be plotted on a map or given to the staff member by other means, as instructions to add a collection activity to the list of tasks. Whether by GPS, Wifi, Bluetooth, etc., triangulation between communication nodes can serve to locate a receptacle on a map, and measurements of fullness of receptacles can be used to create work instructions for staff members or truck drivers, so that efficient routes and schedules can be created to save time.

In one example, with respect to composting receptacles, data regarding the characteristics of a community which can include food purchasing and preparation habits, the provisioning of a number and location of composting receptacles can be based at least in part on such community characteristics such that where composting is more likely in a neighborhood, more receptacles can be placed in those neighborhoods.

To better manage the collection process, user groups can be separated between trash, compost, and recycling personnel. In many cities, there are separate trucks used to collect separate streams of waste, such as trash, compost and recyclables. For this reason, it can be helpful to configure the user's web page to display data based on a waste stream. The data can also be divided in this fashion and displayed differently on a smartphone, hand-held computer, and/or other user device. In addition, data can be displayed differently to different users. For example, the manager of an operation can have “administrative privileges,” and thus can change the location of a particular receptacle in the system, view collection efficiency of a particular waste collector, view login history, and/or view industry or subgroup benchmarks, while a waste collector with lower privileges can only view receptacle fullness, for example. The RCD 244 or another device can also be configured to print a list of receptacles to collect next, a list of full or partially full bins, etc. For example, the remote device 252 can be configured to print a list of receptacles to collect in the remaining portion of a route.

In one aspect, when the receptacle 204 is used for composting, it can be important to know that the proper material is placed in the receptacle 204. For example, regular trash would be inappropriate for the receptacle 204 if it is a community composting bin. Thus, the sensors or PCB 210 can associate the user who uses the mobile device 246 to access the receptacle 204 with an identification or analysis of the type of material placed in the receptacle 204 by that user. Through machine learning algorithms, weight scales, image analysis, and so forth, the receptacle 204 can determine whether the objects placed in the receptacle 204 by a user are composting material (waste food). When the system determines that the objects are proper compost material, a record at the remote device 252 can confirm or record that fact on a per user basis. Rewards or benefits can be provided to that user through a downloaded application on their mobile device 246.

When the system determines that a user has not deposited proper composting material in the receptacle 204 when it is acting as a community composting bin, then that person may have their account locked or their ability to open up the receptacle 204 at a later time blocked until a remedy is provided. For example, they may pay a fine through their application on their mobile device 246 or may have a period of time where they are not allowed to use the receptacle 204. Other remedies may be included as well, such as attendance to a training session on composting and how to use the receptacle 204. Once the remedy is completed, then the user can return to normal access privileges for a receptacle 204.

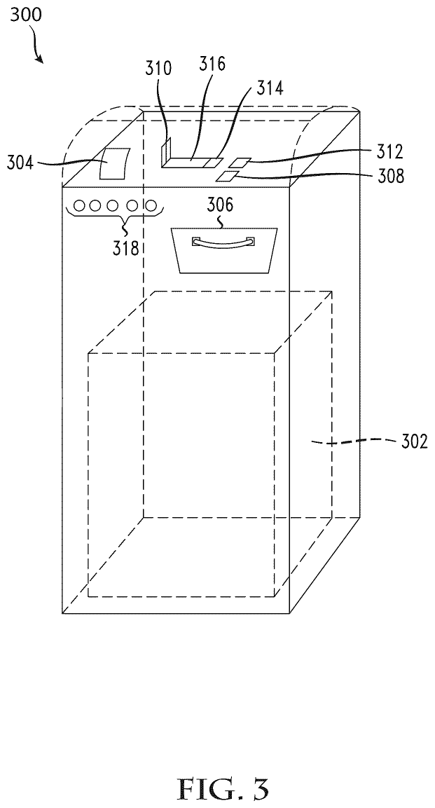

The disclosure now turns to FIG. 3, which illustrates an exemplary storage receptacle 300. The storage receptacle 300 can be configured to dynamically adjusting sensors and compaction operations, as further described below.

The storage receptacle 300 includes a bin 302 for storing content items, and a door 306 for opening the storage receptacle 300 to throw or deposit items in the bin 302. In addition, each of the sensor modules can include an emitter and receiver. Moreover, the storage receptacle 300 can include compactor software or firmware configured to run self-diagnostics on each of the sensor modules and the normal paths, to ensure the storage receptacle 300 is running properly and to report any errors to the management console.

In some configurations, the storage receptacle 300 can also include a sonar sensor 308 to detect objects in the receptacle 300 and calculate the fullness state of the receptacle 300. The signal transmitted and sensed in order to determine trash levels can be any frequency (IR, visual range, etc.) and at any pulse rate. Further, any number and combination of sensors, transmitters, and receivers could be applied in various places within the receptacle 300. The storage receptacle 300 can also include other types of sensors 304, such as an infrared sensor, a temperature sensor, a hall effect sensor, an encoder sensor, a motion sensor, a proximity sensor, etc. The sonar sensor 308 and sensors 304 can sense fullness at regular intervals, and/or based on manual inputs and/or a pre-programmed schedule, for example. Moreover, the sonar sensor 308 and sensors 304 are electrically connected to the printed circuit board (PCB) 316. Further, the sonar sensor 308 and sensor 304 can be actuated by the PCB 316, which can be configured to control the various operations of the storage receptacle 300.

The PCB 316 can control electrical functions performed by the storage receptacle 300. The electrical functions controlled by the PCB 316 can include, for example, running compactions by actuating a motor; sensing waste or recyclables volume inside the receptacle 300 using a sensor at regular or programmable intervals, such as sensors 304; changing status lamps 318 at regular and/or programmable thresholds to/from a color indicating that the receptacle 300 is not full (e.g., green), to/from a color indicating that the receptacle 300 is almost full (e.g., yellow), to/from a color indicating that the receptacle 300 is full (e.g., red); collecting data and transmitting the data to another device; receiving data from another device; managing a power mode; measuring and managing a current; performing diagnostics tests; managing a power source; etc. The motor controller 310 can enable voltage to be applied across a load in either direction. The PCB 316 can use the motor controller 310 to enable a DC motor in the receptacle 300 to run forwards and backwards, to speed or slow, to “brake” the motor, etc.

The storage receptacle 300 includes a transmitter 312 and a receiver 314 for sending and receiving data to and from other devices, such as a server or a remote control device. Accordingly, the storage receptacle 300 can transmit and receive information such as instructions, commands, statistics, alerts, notifications, files, software, data, and so forth. The transmitter 312 and receiver 314 can be electrically connected to the PCB 316. This way, the transmitter 312 can transmit data from the PCB 316 to other devices, and the receiver 314 can receive data from other devices and pass the data for use by the PCB 316. In this regard, a user who is checking the status of the receptacle could drive down the street near the device (say within a wireless range, such as Bluetooth or WIFI, for example), not even get out of their vehicle, but receive a signal indicating that all is well, that the trash needs to be emptied, or that a repair or cleaning is needed.

Status lamps 318 can provide an indication of the status of the storage receptacle 300. For example, the status lamps 318 can indicate the fullness state of the storage receptacle 300. To this end, the status lamps 318 can be configured to display a respective color or pattern when the storage receptacle 300 is full, almost full, not full, etc. For example, the status lamps 318 can be configured to flash red when the storage receptacle 300 is full, yellow when the storage receptacle 300 is almost full, and green when the storage receptacle 300 is not full. Moreover, the status lamps 318 can be LED lights, for example.

The status lamps 318 can also be configured to flash in various patterns to indicate various other conditions. For example, the status lamps 318 can be configured to flash at the same time and in combination to show that the receptacle 300 is full, whether the receptacle 300 receives regular waste or compost. The status lamps 318 can also be configured to flash in different patterns or times or colors to show troubleshooting status information for example. In some cases, the status lamps 318 can be configured to flash in a predetermined manner to show that a door of the receptacle is open, a component is damaged, an obstacle is stuck, an operation is currently active, etc.

As one of ordinary skill in the art will readily recognize, the receptacle 300 can include other components, such as motors, sensors, batteries, solar panels, displays, relays, chargers, GPS devices, timers, fuses, resistors, remote control devices, cameras, etc. However, for the sake of clarity, the receptacle 300 is illustrated without some of these components.

In some configurations, the storage receptacle 300 can be configured to implement dirt sensing technology. The dirt sensing technology can use firmware or other software instructions to monitor the signals, such as infra-red signals, through the sensors on the receptacle 300, and use this data to determine how dirty the detection sensors have become. For example, in some cases, a “clean” sensor 304D can take around 6 38 khz pulses transmitted from a transmitter 304C before the signal is detected. As the sensor becomes more and more, dirty it typically takes longer to detect the signal, and may even take 20 38 khz pulses, for example. This data can be used to provide a scale of how dirty the sensor has become and provide feedback to the user before the sensor becomes completely blocked. Once the sensor is blocked, the capacity of the compactor can be reduced since compactions may no longer performed. As one of ordinary skill in the art will readily recognize, the frequencies and number of pulses discussed herein are provided for non-limiting illustration purposes. In fact, the frequencies used and number of pulses associated with specific dirt levels can vary based on a number of factors, such as hardware and preference settings. Moreover, other applications, frequencies and number of pulses are contemplated herein.

Furthermore, since the voltage of a battery does not generally indicate the actual capacity in a battery, it can be beneficial to understand what capacity is available to ensure accurate machine operation and dead battery notification. To this end, the machine firmware can analyze voltage drops that occur after a compaction occurs at what current and can determine a ratio which can provide feedback and indications of the true battery capacity. The machine firmware can also analyze how fast voltage is dropping based on current wireless usage and predict when an alternative node in the mesh network, and particularly the paired node, should be switched to. For example, if the machine firmware detects that the system will have sufficient capacity for 3 hours of work in 20 minutes, the system can configure a switch between nodes to take place in 20 minutes. If the system calculates the other node, in an active state, will reach a critical power level in 15 minutes, the system can cause a transfer to an active state take place sooner than might otherwise have occurred so that coverage continues. The firmware can use a ratio to limit compactions, sensor activity, wireless/cellular activity, and/or notify the management console of the battery state. As previously mentioned, the management console can be a console on the actual storage receptacle 300 and/or a remote device, such as a server, for example.

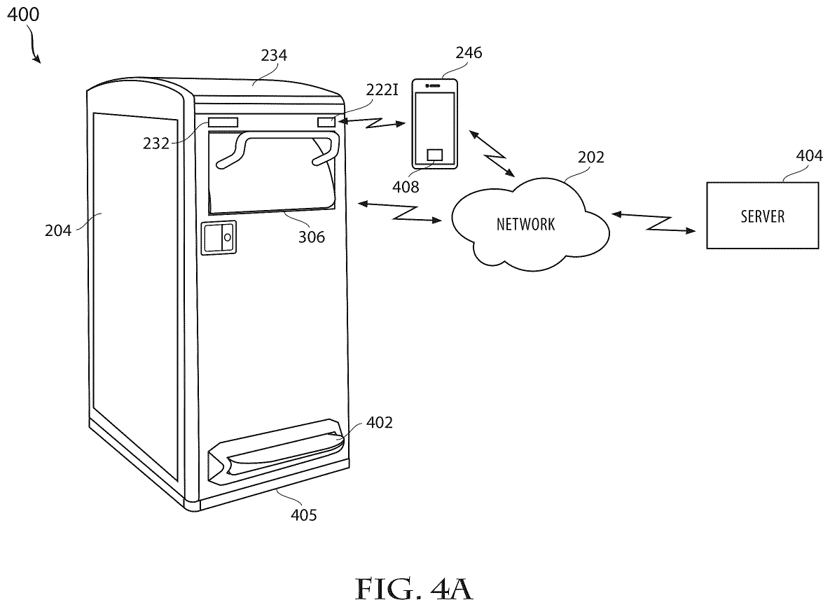

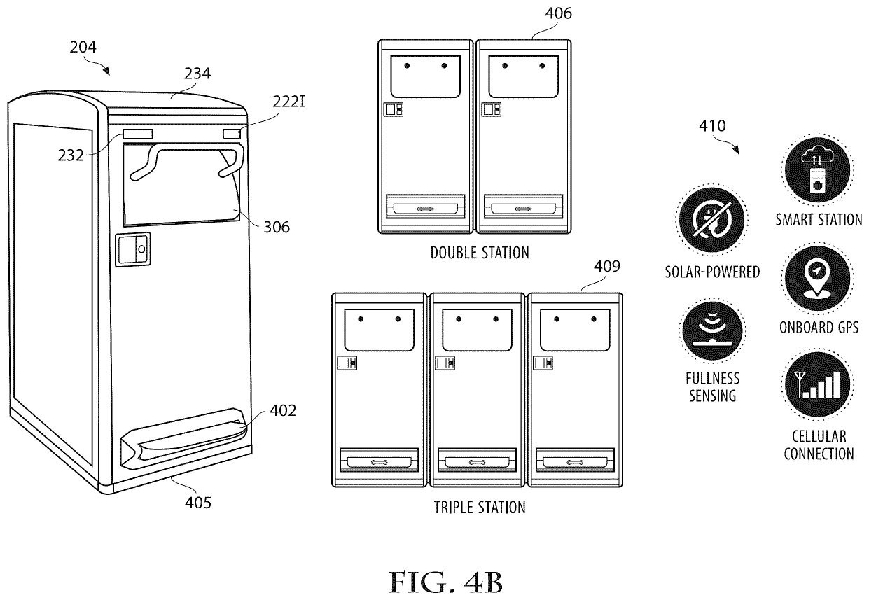

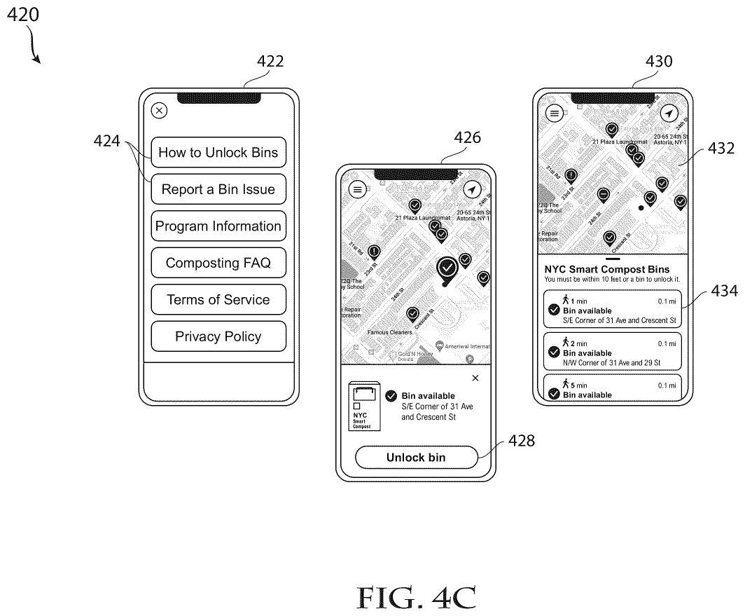

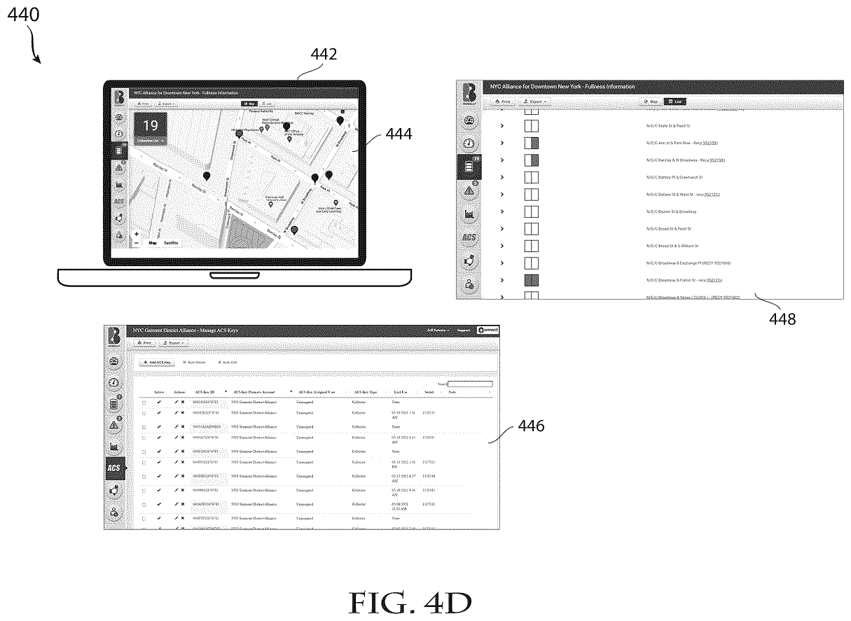

FIG. 4A illustrates several components applicable to the present disclosure. A system 400 can include a receptacle 204 having a scanning module 222I, a hopper 306, a display 232 and a solar panel 234. A mobile device 246 can include an application 408 downloaded thereon that can provide the functionality described herein for enabling a user of the mobile device 236 to interact via the mobile device 246 with the scanning module 222I to unlock the hopper 306 and enable access to the receptacle 204. The mobile device 246 and the receptacle 204 can communicate through a network 202 with a network server 404 having management software for managing a user account that enables the user mobile device 246 to be authorized to unlock the hopper 306 as well as other management functions such as monitoring a status of the receptacle 204 (whether it is full and needs to be emptied, individual user participation, aggregated data, and so forth).

Rather than a downloaded application, the network server 404 can provide a website or App Clips which can be used to perform specific functions without the need of the user downloading an application on the mobile device 246.

An anchor plate 405 can be included to easily and securely mount the receptacle 204 on a sidewalk. A foot pedal 402 can be provided with a delayed-response safety feature which can allow for hand-free compost disposal.

Thus, one “system” can include all of the components including the receptacle 204, the mobile device 246 and/or application 408 and the network server 404. More specifically, the system can include a solar-powered secure receptacle 204 having a control system, a scanning module in communication with the control system, a wireless communication device, and a lockable hopper in communication with the control system; a network device 404 in communication with the solar-powered secure receptacle via the wireless communication device, the network device configured to manage access allowance for a user of the solar-powered secure receptacle via a mobile device; and a user application 408 downloadable onto the mobile device 246. The user application is configured: to present to the user on the mobile device a location and availability of the solar-powered secure receptacle; to unlock the lockable hopper in the solar-powered secure receptacle using the scanning module; to present information what items can be placed in the solar-powered secure receptacle; and to report issues with the solar-powered secure receptacle.

The solar-powered secure receptacle 204 can include a solar-powered secure compost receptacle. The network device 404 can be further configured to monitor a plurality of solar-powered secure receptacles (e.g., compost receptacles) for use by users. In some aspects, the network device 404 or network server can monitor how full one or more compost receptacles 204 is and then guide through the user application 408 where users should go if they have compostable material. For example, as a user leaves their home, they can access the user application 408 and receive updated information regarding where an available composting receptacle 204 is that is near their location. In other aspects, the user application 408 further enables benefits to be provided to the user based on use of the solar-powered secure receptacle. The network server 404 can provide a gamification approach, such as providing rewards for depositing waste food or compost, to make providing compost materials to a receptacle 204 more fun for each user.

The network device 404 can further be configured to turn on access to the solar-powered secure receptacle for enrollees of an access program and turn off access to the solar-powered secure receptacle for users leaving the access program.

In some aspects, the network device 404 can be further configured to present a graphical representation a location of each of a plurality of solar-powered secure receptacles and a respective fullness level of each of the plurality of solar-powered secure receptacles.

The scanning module 222I can include one or more of a radio frequency identification (RFID) scanning module, a near-field communication (NFC) scanning module, a Bluetooth scanning module, or a scannable image for use by the mobile device to obtain access to the solar-powered secure receptacle. The scanning module 222I can also include a graphical object that the mobile device can scan and download a user interface which the user can interact with to obtain a one-time access to the solar-powered secure receptacle. The lockable hopper on the receptacle 204 can enable access, when unlocked, to the solar-powered secure receptacle.

Other aspects of the system can include the concept of scheduling drop-offs for compost materials by users. The network system 404 can determine a predictable schedule or set forth a schedule in which users can be scheduled to drop of compost materials. The timing of when to instruct users to drop off compost can help in load balancing across receptacles 204 as well as maintaining or in accordance with a pick-up schedule for compost material across multiple receptacles 204. In one example, a user may have compost material ready to drop off and could check their application 408 for availability and timing. The user may be able to enter information about how much or a type of compost material that they have. The network server 404 may obtain that data and perform an analysis of one or more requests from users for compost drop off and schedule the user for a drop-off time and receptacle location. For example, the user may be given a calendar and locations near them and asked to pick a time slot in which to drop of their compost. In this manner, the network server 404 can manage the reception of compost material, the pickup of compost material and to some degree manage the type and/or volume of compost material that is being processed in the system. The network server 404 can also manage or grant access to the chosen receptacle 404 for the time slot so that the user can have access to drop of composting material during their allocated time.

In some aspects, some material may introduce more odor at the receptacle 204 than other materials. If the network server 404 for example, knows that an odor-producing compost material is going to be dropped off, the network server 404 might take the type of material into account and request or schedule that it be dropped off by the user at a location where a pickup of the component material is to happen soon thereafter. The access management can then include enabling access for that user for the compost during the window of time scheduled. The user may be able to pay more or request an alternate time dynamically as well but in general, the user can be given a window of time to access the receptacle 204 as scheduled.

FIG. 4B illustrates in more detail the receptacle 204 with the display which can be LED indicators signing such information as drop-off availability, a solar panel 234, the scanning module 222I, the hopper 306. The anchor plate 405 is shown for easily and securely mounting the receptacle 204 on a sidewalk. The foot pedal 402 includes a delayed-response safety feature which allows for hand-free compost disposal.

The receptacle 204 can be included as a double station 406 or a triple station 409 as shown. Each receptacle 204 can be a “smart station” in that it communicates with the network server 404 its status and other data and receives information and instructions from the network server 404. The receptacle 204 can be solar powered and include sensors to sense a fullness status. The receptacle 204 can include a global position system (GPS) component which can be used to identify its location. Further the receptacle 204 can include a cellular connection capability (see transmitter 206 and receiver 208 in FIG. 2) which enables communication through the network 202 with the network server or network device 404.

FIG. 4C illustrates the functionality available via an application downloadable on a mobile device 246 for users or accessible via a website independent of a downloaded application. Mobile device 422 shows selectable objects 424 for information or tasks such as how to unlock bins, how to report a bin issue, program information, composting facts, terms of service and a privacy policy. Other functionality can be provided as well such as rewards for use of the receptacles 204, gamification programs (i.e., earning reward points for use of the system, etc.) for the process, social media aspects of using the receptacles 204 and so forth.

Mobile device 426 shows the use of the application or user interface with a selectable object 428 to unlock a receptacle 204. The user can interact with the object 428 and the system can either through a connection between the mobile device 426 and the receptacle 204 or through the network 202 cause the receptacle 204 to unlock. Other information such as a map can be shown with the location of the receptacles 204 including a status of which ones are available.

Mobile device 420 can show a map 432 of available receptacles 204 and their state as well other information 434 such as the availability of a specific receptacle 204, how long it will take to get there, and its location. In one aspect, the application or user interface may enable a user to open the application and simply be given directions to a nearest one or more receptacles 204 that are currently available to receive compost. Such information may change from time to time as receptacles 204 get filled up or are being serviced. The system can receive user input to the application indicating they are ready to drop off composting material and provide the user with up-to-date availability information and directions.

FIG. 4D illustrates software functionality 440 on the network server 404 or computer used to manage the receptacles 204. For example, on a computer 442, a user interface 444 can provide an overall map view of receptacles 204, their location and an indication of their status. User interface 446 illustrates an example of data stored on a computer 442 associated with individuals with access to one or more of the receptacles 204. Users can have individual access key IDs, individual or group accounts, assigned keys as well as key types. For example, a normal user in a city may have a key type of “citizen” while a worker who needs access to collect compost might have a key type of “collector”. Other information such as a last use of a device can be listed with a location and time as well as other data associated with users and/or individual receptacles 204.

The operator software programmed on the network server 404/442 can be used to manage access allowance for resident users, guest users, and can be used to turn on or off the access availability based on whether someone is an enrollee in a program or has left the program. Individual use access can be tracked as well. In one aspect, the program can provide information such as which users use the system most often, which locations get used the most, what is the timing of usage on a daily basis and what days get the most usage. For example, the system may learn that after holidays like Thanksgiving, there is a high level of usage of the composting system. Thus, collection schedules can be adjusted to prepare for high volume use of the system as managed by the programmed software.

Other aspects can include guest use. For example, if an out-of-town user who is not enrolled in a program wants to use the composting system, they may tap on an NFC tag or the scanning module in the same manner as they may use their mobile device for Apple Pay or Google Pay. The system may present a graphical interface (via an App Clip which is a snippet of an entire application but is used for a specific task) indicating that they can use this receptacle 204 as a guest for a fee of $1 and that by continuing with the authentication process (two clicks, plus FaceID in Apple Pay, or fingerprint approach, or PIN approval, etc.) can cause one or more events to occur: an identification of the user, a detection of what objects they place in the receptacle 204 (to insure that it is compost material), a payment of $1 (for example), and an unlocking of the hopper 306. In this regard, through the same or similar payment process, the access to and processing of the compost material can occur for an un-enrolled user but for a fee. In another aspect, the user may receive or have to view an advertisement to gain access to the receptacle 204. The guest user might also be scheduled or instructed to go to a different receptacle 204 for any number of reasons such as the local receptacle 204 is full or is already expecting another registered user to drop off compost soon and thus its capacity is reserved. It such a context, the capacity of receptacles 204 can be “reserved” by users much like compute resources in cloud computing on-demand data centers offered by companies such as Google and Amazon. In other words, the capacity of one or more receptacle 204 can be reserved for users to fill with compost that they deliver to the one or more receptacles 204. Users can have service level agreements (again, like cloud computing operations) in which they are guaranteed a certain amount of capacity for their composting needs across the multiple receptacles 204 in their area. The network server 404 can be like a workload manager which can intelligently manage the user requirements and access to capacity in a group of receptacles 204 according to their service level agreements or paid-for access rights.

As noted, above, similar aspects can occur through a QR Code in which the user uses a mobile device 246 to scan the code and receive an App Clip or user interface that they can interact with to make a payment to gain access or use their enrolled status to gain access and deposit compost material.

User interface 448 shows data regarding the status of individual receptacles 204 which can relate to a status of battery power, a fullness level of compost for each respective receptacle 204 or other data.

While an application is discussed above that can be downloaded on a user mobile device 246, the functionality disclosed herein may not require an application but may also be used through App Clips or through access to a website or via other capabilities such as an RFID that is separate from a mobile device 246.

In some aspects, the network server 404 can include at least one processor and a computer-readable storage device storing instructions which, when executed by the at least one processor, cause the at least one processor to be configured to perform one or more of the following steps: receive, from a receptacle having a scanning module and via an interaction with a mobile device, an identification of a user; confirm that the user is enrolled in a program associated with accessing the receptacle; when the user is enrolled in the program, causing a hopper of the receptacle to become unlocked to enable the receptacle to receive compost material; receive a report of a fullness level of the receptacle and which users access the receptacle; implement a collection operation for the receptacle and other receptacles according to a schedule that is based on the fullness level of the receptacle and a fullness level of the other receptacles; and manage what users are granted access to the receptacle and the other receptacles. Managing what users are granted access can include scheduling users to drop off compost at an assigned receptacle 204 according to data such as a service level agreement, user profile, historical usage, a type of compost, an amount of compost, a fullness level of one or more receptacles 204, a pick-up schedule, upcoming future events (i.e., Thanksgiving or other holiday or event where compost material production might spike), and/or a predicted use of receptacles 204.

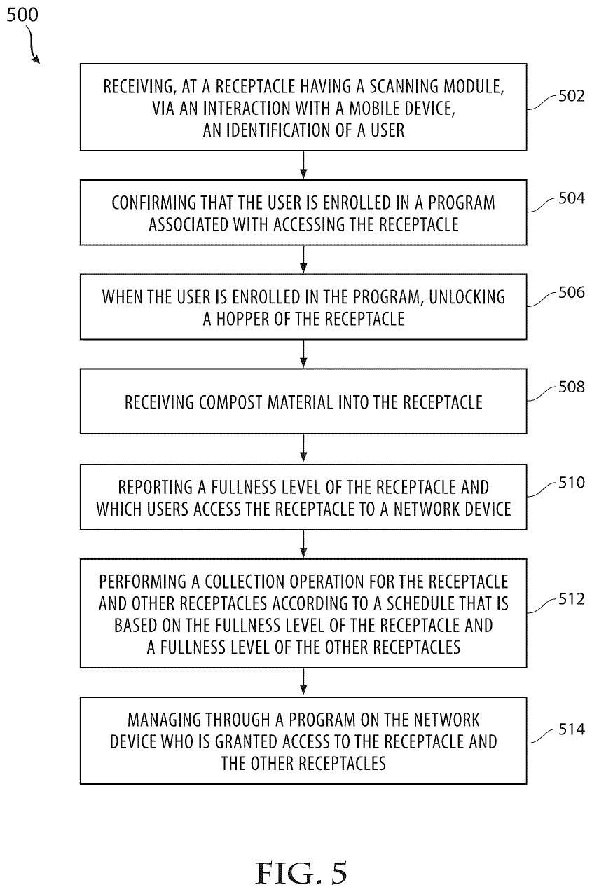

FIG. 5 illustrates a method aspect related to using a system which can include all of the components discussed above. The method 500 can include receiving, at a receptacle having a scanning module, via an interaction with a mobile device, an identification of a user (502), confirming that the user is enrolled in a program associated with accessing the receptacle (504), when the user is enrolled in the program, unlocking a hopper of the receptacle (506), receiving compost material into the receptacle (508), reporting a fullness level of the receptacle and which users access the receptacle to a network device (510), performing a collection operation for the receptacle and other receptacles according to a schedule that is based on the fullness level of the receptacle and a fullness level of the other receptacles (512) and managing through a program on the network device who is granted access to the receptacle and the other receptacles (514). The step of performing a collection operation can include a network server 404 initiating a collection or transmitting instructions to one or more computing devices to initiate or perform a collections operation. The method 500 of FIG. 5 utilizes the various components such as the network server 404, the receptacle 204 and the mobile device 246. Other methods discussed below focus or involve operations performed by just one of the components. Various aspects of this disclosure can include individual components and their functions as well as two or more of the components to make a system that requires multiple components.

The receptacle can include a solar-powered secure compost receptacle 204. The network device 404 can be further configured to monitor a plurality of solar-powered secure receptacles for use by users. The network device 404 can further be configured to turn on access to the receptacle for enrollees of the program and turn off access to the receptacle for users leaving the program and/or schedule, based on data, users for dropping off compost at an assigned receptacle.

The network device 404 can further be configured to present a graphical representation a location of each of a plurality of solar-powered secure receptacles and a respective fullness level of each of the plurality of solar-powered secure receptacles 204.

The scanning module 222I can include one or more of a radio frequency identification (RFID) scanning module, a near-field communication (NFC) scanning module, a Bluetooth scanning module, or a scannable image for use by the mobile device to obtain access to the receptacle.

In one aspect, the scanning module 222I can include a graphical object that the mobile device can scan and download a user interface which the user can interact with to obtain a one-time access to the receptacle. A user interface associated with the mobile device is associated with an App Clip.

The hopper 306 can enable enables access, when unlocked, to the receptacle. A user application on the mobile device 246 can enable benefits (points, refunds, cash, rewards, access, etc.) to be provided to the user based on use of the receptacle.

In another aspect, a system can include a solar-powered secure receptacle 204 including a control system, a scanning module in communication with the control system, a wireless communication device, and a lockable hopper in communication with the control system. The system can include a network device 404 in communication with the solar-powered secure receptacle 204 via the wireless communication device, the network device 404 configured to manage access allowance for a user of the solar-powered secure receptacle 204 via a mobile device 246. A user application can be downloadable onto the mobile device 246 from an App Store or other download service. The user application can be configured: to present to the user on the mobile device 246 a location and availability of the solar-powered secure receptacle 204; to unlock the lockable hopper in the solar-powered secure receptacle 204 using the scanning module; to present information what items can be placed in the solar-powered secure receptacle 204; and to report issues with the solar-powered secure receptacle 204.

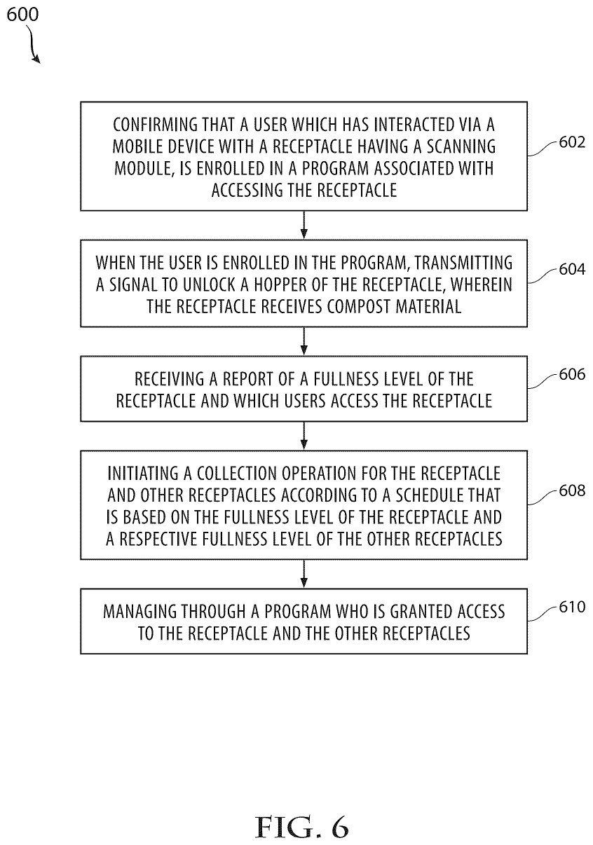

FIG. 6 illustrates an example method 600 from the standpoint of the network server 404. The method 600 can include one or more of the following steps being performed on the network server 404. The method 600 can include confirming that a user which has interacted via a mobile device with a receptacle having a scanning module, is enrolled in a program associated with accessing the receptacle (602) and, when the user is enrolled in the program, transmitting a signal to unlock a hopper of the receptacle, wherein the receptacle receives compost material (604).

The method can further include receiving a report of a fullness level of the receptacle and which users access the receptacle (606), initiating a collection operation for the receptacle and other receptacles according to a schedule that is based on the fullness level of the receptacle and a respective fullness level of the other receptacles (608) and managing through a program who is granted access to the receptacle and the other receptacles. The receptacle in some aspects can include a solar-powered secure compost receptacle 204.

The method further can include monitoring a plurality of solar-powered secure receptacles 204 for use by users. The method further can include turning on access to the receptacle for enrollees of the program and turn off access to the receptacle for users leaving the program and/or scheduling, based on data, users for dropping off compost at an assigned receptacle. Users can be scheduled also to provide materials into an assigned receptacle 204.

In another aspect, the method further can include presenting a graphical representation a location of each of a plurality of solar-powered secure receptacles 204 and a respective fullness level of each of the plurality of solar-powered secure receptacles 204.

In some aspects, the scanning module can include one or more of a radio frequency identification (RFID) scanning module, a near-field communication (NFC) scanning module, a Bluetooth scanning module, or a scannable image for use by the mobile device 246 to obtain access to the receptacle 204. The scanning module also can include a graphical object that the mobile device 246 can scan and download a user interface which the user can interact with to obtain a one-time access to the receptacle 204.

In some aspects, a user interface associated with the mobile device 246 can be associated with an App Clip in which not a full application is downloaded to the mobile device but only the portion needed to perform the function as is the case with Apple “App Clips”. The user application on the mobile device 246 can enable benefits to be provided to the user based on use of the receptacle 204. In some aspects, the hopper enables access, when unlocked, to the receptacle 204.

A system can include at least one processor and a computer-readable storage device storing instructions which, when executed by the at least one processor, cause the at least one processor to be configured to: confirm that a user which has interacted via a mobile device 246 with a receptacle 204 having a scanning module 222I, is enrolled in a program associated with accessing the receptacle 204; when the user is enrolled in the program, transmit a signal to unlock a hopper of the receptacle 204, wherein the receptacle 204 receives compost material; receive a report of a fullness level of the receptacle 204 and which users access the receptacle 204; initiate a collection operation for the receptacle 204 and other receptacles 204 according to a schedule that is based on the fullness level of the receptacle 204 and a respective fullness level of the other receptacles 204; and manage through a program who is granted access to the receptacle 204 and the other receptacles 204. One or more of these operations can be performed by the system and the receptacle 204 can be a compost receptacle.

In some aspects, a solar-powered secure receptacle 204 can include a control system, a scanning module in communication with the control system, a wireless communication device and a lockable hopper in communication with the control system. The wireless communication device can communicate with a network device 404 and the network device 404 can be configured to manage access allowance for a user of the solar-powered secure receptacle 204 via a mobile device 246. A user application can be downloadable onto the mobile device 246 that is configured to: present to the user on the mobile device a location and availability of the solar-powered secure receptacle; unlock the lockable hopper in the solar-powered secure receptacle using the scanning module; present information what items can be placed in the solar-powered secure receptacle 204; and report issues with the solar-powered secure receptacle 204.

The solar-powered secure receptacle 204 can include a solar-powered secure compost receptacle. The network device 404 can be further configured to monitor a plurality of solar-powered secure receptacles 204 for use by users.

In some aspects, the network device 404 can further be configured to turn on access to the solar-powered secure receptacle 204 for enrollees of an access program and turn off access to the solar-powered secure receptacle 204 for users leaving the access program.

In some aspects, the network device 404 can be further configured to present a graphical representation a location of each of a plurality of solar-powered secure receptacles 204 and a respective fullness level of each of the plurality of solar-powered secure receptacles 204.

The scanning module 222I can include one or more of a radio frequency identification (RFID) scanning module, a near-field communication (NFC) scanning module, a Bluetooth scanning module, or a scannable image for use by the mobile device 246 to obtain access to the solar-powered secure receptacle 204. In some aspects, the scanning module can include a graphical object that the mobile device 246 can scan and download a user interface which the user can interact with to obtain a one-time access to the solar-powered secure receptacle 204. The user interface can be associated with an App Clip from Apple as would be known by those of skill in the art. The lockable hopper can enable access, when unlocked, to the solar-powered secure receptacle 204.

The user application further can enable benefits to be provided to the user based on use of the solar-powered secure receptacle 204.

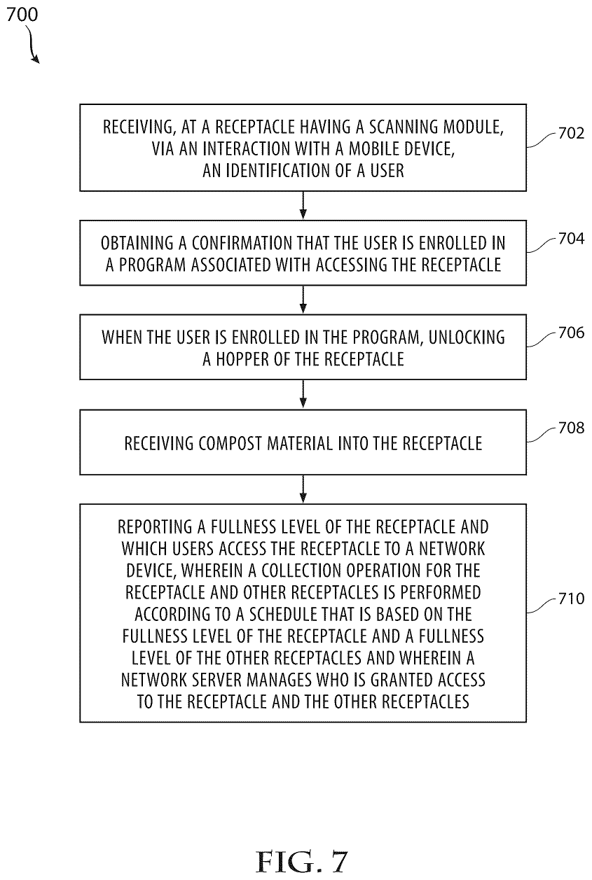

FIG. 7 illustrates a method 700 of operating a receptacle 204. The method 700 can include one or more of: receiving, at a receptacle 204 having a scanning module 222I, via an interaction with a mobile device 246, an identification of a user (702), obtaining a confirmation that the user is enrolled in a program associated with accessing the receptacle 204 (704), when the user is enrolled in the program, unlocking a hopper of the receptacle 204 (706), receiving compost material into the receptacle 204 (708) and reporting a fullness level of the receptacle 204 and which users access the receptacle 204 to a network device 404, wherein a collection operation for the receptacle and other receptacles is performed according to a schedule that is based on the fullness level of the receptacle 204 and a fullness level of the other receptacles 204 and wherein a network server 404 manages who is granted access to the receptacle 204 and the other receptacles 204 (710).

In some aspects, a storage receptacle 204 can include a scanning module; a hopper; at least one processor and a computer-readable storage device storing instructions which, when executed by the at least one processor, cause the at least one processor to be configured to: receive, via an interaction with a mobile device 246, an identification of a user; obtain a confirmation that the user is enrolled in a program associated with accessing the storage receptacle 204; when the user is enrolled in the program, unlock the hopper; receive compost material into the storage receptacle 204; and report a fullness level of the storage receptacle 204 and which users access the storage receptacle to a network server 404, wherein a collection operation for the storage receptacle 204 and other storage receptacles 204 is performed according to a schedule that is based on the fullness level of the storage receptacle 204 and a fullness level of the other storage receptacles 204 and wherein the network server 404 manages who is granted access to the storage receptacle and the other storage receptacles.

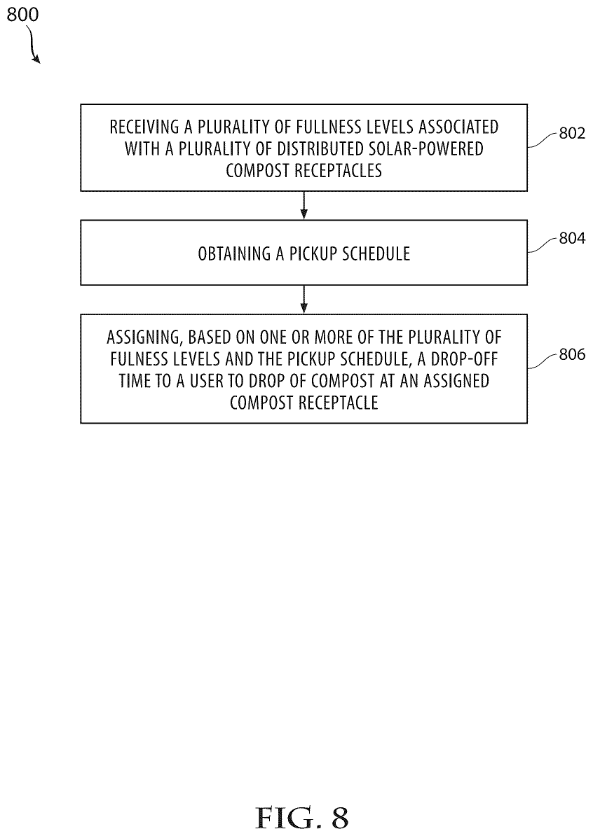

Another method can relate to assigning users specific times or time frames and a chosen compost receptacle based on some data. For example, as shown in FIG. 8, a method 800 can include: receiving a plurality of fullness levels associated with a plurality of distributed solar-powered compost receptacles (802); obtaining a pickup schedule (804); and assigning, based on one or more of the plurality of fullness levels and the pickup schedule, a drop-off time to a user to drop of compost at an assigned compost receptacle (806).

A system can include least one processor; and a computer-readable storage device storing instructions which, when executed by the at least one processor, cause the at least one processor to be configured to: receive a plurality of fullness levels associated with a plurality of distributed solar-powered compost receptacles; obtain a pickup schedule; and assign, based on one or more of the plurality of fullness levels and the pickup schedule, a drop-off time to a user to drop of compost at an assigned compost receptacle.

Aspects within the scope of the present disclosure may also include tangible and/or non-transitory computer-readable storage devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other aspects of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Aspects may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various aspects described above are provided by way of illustration only and should not be construed to limit the scope of the disclosure. Various modifications and changes may be made to the principles described herein without following the example aspects and applications illustrated and described herein, and without departing from the spirit and scope of the disclosure. Claim language reciting “at least one of” a set indicates that one member of the set or multiple members of the set satisfy the claim.

Claim clauses for this application can include:

Clause 1. A system comprising: a solar-powered secure receptacle comprising a control system, a scanning module in communication with the control system, a wireless communication device, and a lockable hopper in communication with the control system; a network device in communication with the solar-powered secure receptacle via the wireless communication device, the network device configured to manage access allowance for a user of the solar-powered secure receptacle via a mobile device; and a user application downloadable onto the mobile device, wherein the user application is configured: to present to the user on the mobile device a location and availability of the solar-powered secure receptacle; to unlock the lockable hopper in the solar-powered secure receptacle using the scanning module; to present information what items can be placed in the solar-powered secure receptacle; and to report issues with the solar-powered secure receptacle.

Clause 2. The system of clause 1, wherein the solar-powered secure receptacle comprises a solar-powered secure compost receptacle.

Clause 3. The system of clause 1 or any previous clause, wherein the network device is further configured to monitor a plurality of solar-powered secure receptacles for use by users.

Clause 4. The system of clause 1 or any previous clause, wherein the network device is further configured to turn on access to the solar-powered secure receptacle for enrollees of an access program and turn off access to the solar-powered secure receptacle for users leaving the access program.

Clause 5. The system of clause 1 or any previous clause, wherein the network device is further configured to present a graphical representation a location of each of a plurality of solar-powered secure receptacles and a respective fullness level of each of the plurality of solar-powered secure receptacles.

Clause 6. The system of clause 1 or any previous clause, wherein the scanning module comprises one or more of a radio frequency identification (RFID) scanning module, a near-field communication (NFC) scanning module, a Bluetooth scanning module, or a scannable image for use by the mobile device to obtain access to the solar-powered secure receptacle.

Clause 7. The system of clause 1 or any previous clause, wherein the scanning module comprises a graphical object that the mobile device can scan and download a user interface which the user can interact with to obtain a one-time access to the solar-powered secure receptacle.

Clause 8. The system of clause 7 or any previous clause, wherein the user interface can be associated with an App Clip.

Clause 9. The system of clause 1 or any previous clause, wherein the lockable hopper enables access, when unlocked, to the solar-powered secure receptacle.

Clause 10. The system of clause 1 or any previous clause, wherein the user application further enables benefits to be provided to the user based on use of the solar-powered secure receptacle.

Clause 11. A method comprising: receiving, at a receptacle having a scanning module, via an interaction with a mobile device, an identification of a user; confirming that the user is enrolled in a program associated with accessing the receptacle; when the user is enrolled in the program, unlocking a hopper of the receptacle; receiving compost material into the receptacle; reporting a fullness level of the receptacle and which users access the receptacle to a network device; performing a collection operation for the receptacle and other receptacles according to a schedule that is based on the fullness level of the receptacle and a fullness level of the other receptacles; and managing through a program on the network device who is granted access to the receptacle and the other receptacles.

Clause 12. The method of clause 11 or any previous clause, wherein the receptacle comprises a solar-powered secure compost receptacle.

Clause 13. The method of clause 11 or any previous clause, wherein the network device is further configured to monitor a plurality of solar-powered secure receptacles for use by users.

Clause 14. The method of clause 11 or any previous clause, wherein the network device is further configured to turn on access to the receptacle for enrollees of the program and turn off access to the receptacle for users leaving the program and/or schedule, based on data, users for dropping off compost at an assigned receptacle.

Clause 15. The method of clause 11 or any previous clause, wherein the network device is further configured to present a graphical representation a location of each of a plurality of solar-powered secure receptacles and a respective fullness level of each of the plurality of solar-powered secure receptacles.

Clause 16. The method of clause 11 or any previous clause, wherein the scanning module comprises one or more of a radio frequency identification (RFID) scanning module, a near-field communication (NFC) scanning module, a Bluetooth scanning module, or a scannable image for use by the mobile device to obtain access to the receptacle.

Clause 17. The method of clause 11 or any previous clause, wherein the scanning module comprises a graphical object that the mobile device can scan and download a user interface which the user can interact with to obtain a one-time access to the receptacle.

Clause 18. The method of clause 17 or any previous clause, wherein a user interface associated with the mobile device is associated with an App Clip.

Clause 19. The method of clause 11 or any previous clause, wherein the hopper enables access, when unlocked, to the receptacle.

Clause 20. The method of clause 11 or any previous clause, wherein a user application on the mobile device enables benefits to be provided to the user based on use of the receptacle.

Clause 21. A method of operating a network server, the method comprising: confirming that a user which has interacted via a mobile device with a receptacle having a scanning module, is enrolled in a program associated with accessing the receptacle; when the user is enrolled in the program, transmitting a signal to unlock a hopper of the receptacle, wherein the receptacle receives compost material; receiving a report of a fullness level of the receptacle and which users access the receptacle; initiating a collection operation for the receptacle and other receptacles according to a schedule that is based on the fullness level of the receptacle and a respective fullness level of the other receptacles; and managing through a program who is granted access to the receptacle and the other receptacles.

Clause 22. The method of clause 21 or any previous clause, wherein the receptacle comprises a solar-powered secure compost receptacle.

Clause 23. The method of clause 21 or any previous clause, wherein the method further comprises monitoring a plurality of solar-powered secure receptacles for use by users.

Clause 24. The method of clause 21 or any previous clause, wherein the method further comprises turning on access to the receptacle for enrollees of the program and turn off access to the receptacle for users leaving the program and/or scheduling, based on data, users for dropping off compost at an assigned receptacle.

Clause 25. The method of clause 21 or any previous clause, wherein the method further comprises presenting a graphical representation a location of each of a plurality of solar-powered secure receptacles and a respective fullness level of each of the plurality of solar-powered secure receptacles.

Clause 26. The method of clause 21 or any previous clause, wherein the scanning module comprises one or more of a radio frequency identification (RFID) scanning module, a near-field communication (NFC) scanning module, a Bluetooth scanning module, or a scannable image for use by the mobile device to obtain access to the receptacle.

Clause 27. The method of clause 21 or any previous clause, wherein the scanning module comprises a graphical object that the mobile device can scan and download a user interface which the user can interact with to obtain a one-time access to the receptacle.

Clause 28. The method of clause 27 or any previous clause, wherein a user interface associated with the mobile device is associated with an App Clip.

Clause 29. The method of clause 21 or any previous clause, wherein the hopper enables access, when unlocked, to the receptacle.

Clause 30. The method of clause 21 or any previous clause, wherein a user application on the mobile device enables benefits to be provided to the user based on use of the receptacle.

Clause 31. A system comprising: at least one processor; and a computer-readable storage device storing instructions which, when executed by the at least one processor, cause the at least one processor to be configured to: confirm that a user which has interacted via a mobile device with a receptacle having a scanning module, is enrolled in a program associated with accessing the receptacle; when the user is enrolled in the program, transmit a signal to unlock a hopper of the receptacle, wherein the receptacle receives compost material; receive a report of a fullness level of the receptacle and which users access the receptacle; initiate a collection operation for the receptacle and other receptacles according to a schedule that is based on the fullness level of the receptacle and a respective fullness level of the other receptacles; and manage through a program who is granted access to the receptacle and the other receptacles.

Clause 32. A solar-powered secure receptacle comprising: a control system; a scanning module in communication with the control system; a wireless communication device; and a lockable hopper in communication with the control system, wherein: the wireless communication device communicates with a network device; the network device configured to manage access allowance for a user of the solar-powered secure receptacle via a mobile device; and a user application downloadable onto the mobile device is configured to: present to the user on the mobile device a location and availability of the solar-powered secure receptacle; unlock the lockable hopper in the solar-powered secure receptacle using the scanning module; present information what items can be placed in the solar-powered secure receptacle; and report issues with the solar-powered secure receptacle.

Clause 33. The solar-powered secure receptacle of clause 32 or any previous clause, wherein the solar-powered secure receptacle comprises a solar-powered secure compost receptacle.

Clause 34. The solar-powered secure receptacle of clause 32 or any previous clause, wherein the network device is further configured to monitor a plurality of solar-powered secure receptacles for use by users.

Clause 35. The solar-powered secure receptacle of clause 32 or any previous clause, wherein the network device is further configured to turn on access to the solar-powered secure receptacle for enrollees of an access program and turn off access to the solar-powered secure receptacle for users leaving the access program.

Clause 36. The solar-powered secure receptacle of clause 32 or any previous clause, wherein the network device is further configured to present a graphical representation a location of each of a plurality of solar-powered secure receptacles and a respective fullness level of each of the plurality of solar-powered secure receptacles.

Clause 37. The solar-powered secure receptacle of clause 32 or any previous clause, wherein the scanning module comprises one or more of a radio frequency identification (RFID) scanning module, a near-field communication (NFC) scanning module, a Bluetooth scanning module, or a scannable image for use by the mobile device to obtain access to the solar-powered secure receptacle.

Clause 38. The solar-powered secure receptacle of clause 32 or any previous clause, wherein the scanning module comprises a graphical object that the mobile device can scan and download a user interface which the user can interact with to obtain a one-time access to the solar-powered secure receptacle.

Clause 39. The solar-powered secure receptacle of clause 38 or any previous clause, wherein the user interface can be associated with an App Clip.

Clause 40. The solar-powered secure receptacle of clause 32 or any previous clause, wherein the lockable hopper enables access, when unlocked, to the solar-powered secure receptacle.

Clause 41. The solar-powered secure receptacle of clause 32 or any previous clause, wherein the user application further enables benefits to be provided to the user based on use of the solar-powered secure receptacle.

Clause 42. A method of operating a receptacle, the method comprising: receiving, at a receptacle having a scanning module, via an interaction with a mobile device, an identification of a user; obtaining a confirmation that the user is enrolled in a program associated with accessing the receptacle; when the user is enrolled in the program, unlocking a hopper of the receptacle; receiving compost material into the receptacle; and reporting a fullness level of the receptacle and which users access the receptacle to a network server, wherein a collection operation for the receptacle and other receptacles is performed according to a schedule that is based on the fullness level of the receptacle and a fullness level of the other receptacles and wherein the network server manages who is granted access to the receptacle and the other receptacles.

Clause 43. The method of operating the receptacle of clause 42 or any previous clause, wherein the receptacle comprises a solar-powered secure compost receptacle.

Clause 44. The method of operating the receptacle of clause 42 or any previous clause, wherein the network device is further configured to monitor a plurality of solar-powered secure receptacles for use by users.

Clause 45. The method of operating the receptacle of clause 42 or any previous clause, wherein the network device is further configured to turn on access to the receptacle for enrollees of the program and turn off access to the receptacle for users leaving the program and/or schedule, based on data, users for dropping off compost at an assigned receptacle.

Clause 46. The method of operating the receptacle of clause 42 or any previous clause, wherein the network device is further configured to present a graphical representation a location of each of a plurality of solar-powered secure receptacles and a respective fullness level of each of the plurality of solar-powered secure receptacles.

Clause 47. The method of operating the receptacle of clause 42 or any previous clause, wherein the scanning module comprises one or more of a radio frequency identification (RFID) scanning module, a near-field communication (NFC) scanning module, a Bluetooth scanning module, or a scannable image for use by the mobile device to obtain access to the receptacle.

Clause 48. The method of operating the receptacle of clause 42 or any previous clause, wherein the scanning module comprises a graphical object that the mobile device can scan and download a user interface which the user can interact with to obtain a one-time access to the receptacle.

Clause 49. The method of operating the receptacle of clause 48 or any previous clause, wherein a user interface associated with the mobile device is associated with an App Clip.

Clause 50. The method of operating the receptacle of clause 42 or any previous clause, wherein the hopper enables access, when unlocked, to the receptacle.

Clause 51. The method of operating the receptacle of clause 42 or any previous clause, wherein a user application on the mobile device enables benefits to be provided to the user based on use of the receptacle.

Clause 52. A storage receptacle comprising: a scanning module; a hopper; at least one processor; and a computer-readable storage device storing instructions which, when executed by the at least one processor, cause the at least one processor to be configured to: receive, via an interaction with a mobile device, an identification of a user; obtain a confirmation that the user is enrolled in a program associated with accessing the storage receptacle; when the user is enrolled in the program, unlock the hopper; receive compost material into the storage receptacle; and report a fullness level of the storage receptacle and which users access the storage receptacle to a network server, wherein a collection operation for the storage receptacle and other storage receptacles is performed according to a schedule that is based on the fullness level of the storage receptacle and a fullness level of the other storage receptacles and wherein the network server manages who is granted access to the storage receptacle and the other storage receptacles.

Clause 53. A method comprising: receiving a plurality of fullness levels associated with a plurality of distributed solar-powered compost receptacles; obtaining a pickup schedule; and assigning, based on one or more of the plurality of fullness levels and the pickup schedule, a drop-off time to a user to drop of compost at an assigned compost receptacle.

Clause 54. A system comprising: at least one processor; and a computer-readable storage device storing instructions which, when executed by the at least one processor, cause the at least one processor to be configured to: receive a plurality of fullness levels associated with a plurality of distributed solar-powered compost receptacles; obtain a pickup schedule; and assign, based on one or more of the plurality of fullness levels and the pickup schedule, a drop-off time to a user to drop of compost at an assigned compost receptacle.

We claim:

1. A system comprising:
a solar-powered secure receptacle comprising a control system, a scanning module in communication with the control system, a wireless communication device, and a lockable hopper in communication with the control system;
a network device in communication with the solar-powered secure receptacle via the wireless communication device, the network device configured to manage access allowance for a user of the solar-powered secure receptacle via a mobile device; and
a user application downloadable onto the mobile device, wherein the user application is configured:
to present to the user on the mobile device a location and availability of the solar-powered secure receptacle;
to unlock the lockable hopper in the solar-powered secure receptacle using the scanning module;
to present information what items can be placed in the solar-powered secure receptacle; and
to report issues with the solar-powered secure receptacle.

2. The system of claim 1, wherein the solar-powered secure receptacle comprises a solar-powered secure compost receptacle.

3. The system of claim 1, wherein the network device is further configured to monitor a plurality of solar-powered secure receptacles for use by users.

4. The system of claim 1, wherein the network device is further configured to turn on access to the solar-powered secure receptacle for enrollees of an access program and turn off access to the solar-powered secure receptacle for users leaving the access program.

5. The system of claim 1, wherein the network device is further configured to present a graphical representation a location of each of a plurality of solar-powered secure receptacles and a respective fullness level of each of the plurality of solar-powered secure receptacles.

6. The system of claim 1, wherein the scanning module comprises one or more of a radio frequency identification (RFID) scanning module, a near-field communication (NFC) scanning module, a Bluetooth scanning module, or a scannable image for use by the mobile device to obtain access to the solar-powered secure receptacle.

7. The system of claim 1, wherein the scanning module comprises a graphical object that the mobile device can scan and download a user interface which the user can interact with to obtain a one-time access to the solar-powered secure receptacle.

8. The system of claim 7, wherein the user interface can be associated with an App Clip.

9. The system of claim 1, wherein the lockable hopper enables access, when unlocked, to the solar-powered secure receptacle.

10. The system of claim 1, wherein the user application further enables benefits to be provided to the user based on use of the solar-powered secure receptacle.

11. A method comprising:
receiving, at a receptacle having a scanning module, via an interaction with a mobile device, an identification of a user;
confirming that the user is enrolled in a program associated with accessing the receptacle;
when the user is enrolled in the program, unlocking a hopper of the receptacle;
receiving compost material into the receptacle;
reporting a fullness level of the receptacle and which users access the receptacle to a network device;
performing a collection operation for the receptacle and other receptacles according to a schedule that is based on the fullness level of the receptacle and a fullness level of the other receptacles; and
managing through a program on the network device who is granted access to the receptacle and the other receptacles.

12. The method of claim 11, wherein the receptacle comprises a solar-powered secure compost receptacle.

13. The method of claim 11, wherein the network device is further configured to monitor a plurality of solar-powered secure receptacles for use by users.

14. The method of claim 11, wherein the network device is further configured to turn on access to the receptacle for enrollees of the program and turn off access to the receptacle for users leaving the program and schedule, based on data, users for dropping off compost at an assigned receptacle.

15. The method of claim 11, wherein the network device is further configured to present a graphical representation a location of each of a plurality of solar-powered secure receptacles and a respective fullness level of each of the plurality of solar-powered secure receptacles.

16. The method of claim 11, wherein the scanning module comprises one or more of a radio frequency identification (RFID) scanning module, a near-field communication (NFC) scanning module, a Bluetooth scanning module, or a scannable image for use by the mobile device to obtain access to the receptacle.

17. The method of claim 11, wherein the scanning module comprises a graphical object that the mobile device can scan and download a user interface which the user can interact with to obtain a one-time access to the receptacle.

18. The method of claim 17, wherein a user interface associated with the mobile device is associated with an App Clip.

19. The method of claim 11, wherein the hopper enables access, when unlocked, to the receptacle and wherein a user application on the mobile device enables benefits to be provided to the user based on use of the receptacle.

20. A network server comprising:
at least one processor; and
a computer-readable storage device storing instructions which, when executed by the at least one processor, cause the at least one processor to be configured to:
receive, from a receptacle having a scanning module and via an interaction with a mobile device, an identification of a user;
confirm that the user is enrolled in a program associated with accessing the receptacle;
when the user is enrolled in the program, causing a hopper of the receptacle to become unlocked to enable the receptacle to receive compost material;
receive a report of a fullness level of the receptacle and which users access the receptacle;
implement a collection operation for the receptacle and other receptacles according to a schedule that is based on the fullness level of the receptacle and a fullness level of the other receptacles; and
manage what users are granted access to the receptacle and the other receptacles.
